(19) United States
(12) Patent Application Publication
(10) Pub. No.: US 2005/0253924 A1
(43) Pub. Date: Nov. 17, 2005

(54) Method and apparatus for processing three-dimensional images

(76) Inventor: Ken Mashitani, Osaka (JP)

Correspondence Address: MCDERMOTT WILL & EMERY LLP, 600 13TH STREET, N.W., WASHINGTON, DC, 20005-3096, US

(21) Appl. No.: 11/128,433

(22) Filed: May 13, 2005

(30) Foreign Application Priority Data
May 13, 2004 (JP) 2004-144150
Apr. 28, 2005 (JP) 2005-133529

(51) Int. Cl. H04N 13/00

(52) U.S. Cl. 348/42

(57) ABSTRACT

A 3D image processing apparatus first generates a combined view volume that contains view volumes set respectively by a plurality of real cameras, based on a single temporary camera placed in a virtual 3D space. Then, this apparatus performs skewing transformation on the combined view volume so as to acquire view volumes for each of the plurality of real cameras. Finally, two view volumes acquired for the each of the plurality of real cameras are projected on a projection plane so as to produce 2D images having parallax. Using the temporary camera alone, the 2D images serving as base points for a parallax image can be produced by acquiring the view volumes for the each of the plurality of real cameras. As a result, a processing for actually placing the real cameras can be skipped, so that a high-speed processing as a whole can be realized.

### BACKGROUND OF THE INVENTION

1. Field of the Invention

The present invention relates to a stereo image processing technology, and it particularly relates to method and apparatus for producing stereo images based on parallax images.

2. Description of the Related Art

In recent years, inadequacy of network infrastructure has often been an issue, but in this time of transition toward broadband age, it is rather the inadequacy in the kind and number of contents utilizing effectively broadband that is drawing more of our attention. Images have always been the most important means of expression, but most of the attempts so far have been at improving the quality of display or data compression ratio. In contrast, technical attempts and efforts at expanding the possibilities of expression itself seem to be falling behind.

Under such circumstances, three-dimensional image display (hereinafter referred to simply as “3D display” also) has been studied in various manners and has found practical applications in somewhat limited markets, which include uses in the theater or ones with the help of special display devices. In the near future, it is expected that the research and development in this area may further accelerate toward the offering of contents full of realism and presence and the times may come when individual users easily enjoy 3D display at home.

The 3D display is expected to find broader use in the future, and for that reason, there are propositions for new modes of display so far unimaginable with existing display devices. For example, Reference (1) listed in the following Related Art List discloses a technology for three-dimensionally displaying selected partial images of a two-dimensional image.

Related Art List

(1) Japanese Patent Application Laid-Open No. Hei11-39507.

According to the technology introduced in Reference (1), a desired portion of a plane image can be displayed three-dimensionally. This particular technology, however, is not intended to realize a high speed for the 3D display processing as a whole. A new methodology needs to be invented to realize a high speed processing.

### SUMMARY OF THE INVENTION

The present invention has been made in view of the foregoing circumstances and problems, and an object thereof is to provide method and apparatus for processing three-dimensional images that realize the 3D display processing as a whole at high speed.

A preferred mode of carrying out the present invention relates to a three-dimensional image processing apparatus. This apparatus is a three-dimensional image processing apparatus that displays an object within a virtual three-dimensional space based on two-dimensional images from a plurality of different viewpoints, and this apparatus includes: a view volume generator which generates a combined view volume that contains view volumes defined by the respective plurality of viewpoints. For example, the combined view volume may be generated based on a temporary viewpoint. According to this mode of carrying out the present invention, the view volume for each of the plurality of viewpoints can be acquired from the combined view volume generated based on the temporary viewpoint, so that a plurality of two-dimensional images that serve as base points of 3D display can be generated using the temporary viewpoint. The efficient 3D image processing can be achieved thereby.

This apparatus may further include: an object defining unit which positions the object within the virtual three-dimensional space; and a temporary viewpoint placing unit which places a temporary viewpoint within the virtual three-dimensional space, wherein the view volume generator may generate the combined view volume based on the temporary viewpoint placed by the temporary viewpoint placing unit.

This apparatus may further include: a coordinate conversion unit which performs coordinate conversion on the combined view volume and acquires a view volume for each of the plurality of viewpoints; and a two-dimensional image generator which projects the acquired view volume for the each of the plurality of viewpoints, on a projection plane and which generates the two-dimensional image for the each of the plurality of viewpoints.

The coordinate conversion unit may acquire a view volume for each of the plurality of viewpoints by subjecting the view volume to skewing transformation. The coordinate conversion unit may acquire a view volume for each of the plurality of viewpoints by subjecting the view volume to rotational transformation.

The view volume generator may generate the combined view volume by increasing a viewing angle of the temporary viewpoint. The view volume generator may generate the combined view volume by the use of a front projection plane and a back projection plane. The view volume generator may generate the combined view volume by the use of a nearer-positioned maximum parallax amount and a farther-positioned maximum parallax amount. The view volume generator may generate the combined view volume by the use of either a nearer-positioned maximum parallax amount or a farther-positioned maximum parallax amount.

This apparatus may further include a normalizing transformation unit which transforms the combined view volume generated into a normalized coordinate system, wherein the normalizing transformation unit may perform a compression processing in a depth direction on the object positioned by the object defining unit, according to a distance in the depth direction from the temporary viewpoint placed by the temporary viewpoint placing unit. The normalizing transformation unit may perform the compression processing in a manner such that the larger the distance in the depth direction, the higher a compression ratio in the depth direction.

The normalizing transformation unit may perform the compression processing such that a compression ratio in the depth direction becomes small gradually toward a point in the depth direction from the temporary viewpoint placed by the temporary viewpoint placing unit.

The apparatus may further include a parallax control unit which controls the nearer-positioned maximum parallax amount or the farther-positioned maximum parallax amount so that a parallax formed by a ratio of the width to the depth of an object expressed within a three-dimensional image at the time of generating the three-dimensional image does not exceed a parallax range properly perceived by human eyes.

This apparatus may further include: an image determining unit which performs frequency analysis on a three-dimensional image to be displayed based on a plurality of two-dimensional images corresponding to different parallaxes; and a parallax control unit which adjusts the nearer-positioned maximum parallax amount or the farther-positioned maximum parallax amount according to an amount of high frequency component determined by the frequency analysis. If the amount of high frequency component is large, the parallax control unit may adjust the nearer-positioned maximum parallax amount or the farther-positioned maximum parallax amount by making it larger.

This apparatus may further include: an image determining unit which detects movement of a three-dimensional image displayed based on a plurality of two-dimensional images corresponding to different parallaxes; and a parallax control unit which adjusts the nearer-positioned maximum parallax amount or the farther-positioned maximum parallax amount according to an amount of movement of the three-dimensional image. If the amount of movement of the three-dimensional image is large, the parallax control unit may adjust the nearer-positioned maximum parallax amount or the farther-positioned maximum parallax amount by making it larger.

Another preferred mode of carrying out the present invention relates to a method for processing three-dimensional images. This method includes: positioning an object within a virtual three-dimensional space; placing a temporary viewpoint within the virtual three-dimensional space; generating a combined view volume that contains view volumes set respectively by a plurality of viewpoints by which to produce two-dimensional images having parallax, based on the temporary viewpoint placed within the virtual three-dimensional space; performing coordinate conversion on the combined view volume and acquiring a view volume for each of the plurality of viewpoints; and projecting the acquired view volume for the each of the plurality of viewpoints, on a projection plane and generating the two-dimensional image for the each of the plurality of viewpoints.

It is to be noted that any arbitrary combination of the above-described components and expressions mutually replaced by among a method, an apparatus, a system, a recording medium, a computer program and so forth are all effective as and encompassed by the modes of carrying out the present invention.

### BRIEF DESCRIPTION OF THE DRAWINGS

FIG. 1 illustrates a structure of a three-dimensional image processing apparatus according to a first embodiment of the present invention.

FIG. 2A and FIG. 2B show respectively a left-eye image and a right-eye image displayed by a three-dimensional sense adjusting unit of a three-dimensional image processing apparatus.

FIG. 3 shows a plurality of objects, having different parallaxes, displayed by a three-dimensional sense adjusting unit of a three-dimensional image processing apparatus.

FIG. 4 shows an object, whose parallax varies, displayed by a three-dimensional sense adjusting unit of a three-dimensional image processing apparatus.

FIG. 5 illustrates a relationship between the angle of view of a temporary camera and the number of pixels in the horizontal direction of two-dimensional images.

FIG. 6 illustrates a nearer-positioned maximum parallax amount and a farther-positioned maximum parallax amount in a virtual three-dimensional space.

FIG. 7 illustrates a representation of the amount of displacement in the horizontal direction in units in a virtual three-dimensional space.

FIG. 8 illustrates how a combined view volume is generated based on a first horizontal displacement amount and a second horizontal displacement amount.

FIG. 9 illustrates a relationship among a combined view volume, a right-eye view volume and a left-eye view volume after normalizing transformation, according to the first embodiment.

FIG. 10 illustrates a right-eye view volume after a skew transform processing, according to the first embodiment.

FIG. 11 is a flowchart showing a processing to generate parallax images according to the first embodiment.

FIG. 12 illustrates how a combined view volume is generated by increasing the viewing angle of a temporary camera according to a second embodiment of the present invention.

FIG. 13 illustrates a relationship among a combined view volume, a right-eye view volume and a left-eye view volume after normalizing transformation, according to the second embodiment.

FIG. 14 illustrates a right-eye view volume after a skew transform processing, according to the second embodiment.

FIG. 15 is a flowchart showing a processing to generate parallax images according to the second embodiment.

FIG. 16 illustrates how a combined view volume is generated by using a front projection plane and a back projection plane according to a third embodiment of the present invention.

FIG. 17 illustrates a relationship among a combined view volume, a right-eye view volume and a left-eye view volume after normalizing transformation, according to the third embodiment.

FIG. 18 illustrates a right-eye view volume after a skew transform processing, according to the third embodiment.

FIG. 19 illustrates a structure of a three-dimensional image processing apparatus according to a fourth embodiment of the present invention.

FIG. 20 illustrates a relationship among a combined view volume after normalizing transformation, a right-eye view volume and a left-eye view volume according to the fourth embodiment.

FIG. 21 is a flowchart showing a processing to generate parallax images according to the fourth embodiment.

FIG. 22 schematically illustrates a compression processing in the depth direction by the normalizing transformation unit.

FIG. 23A illustrates a first relationship between values in the Z′-axis direction and those in the Z-axis direction in a compression processing; and FIG. 23B illustrates a second relationship between values in the Z′-axis direction and those in the Z-axis direction in a compression processing.

FIG. 24 illustrates a structure of a three-dimensional image processing apparatus according to an eighth embodiment of the present invention.

FIG. 25 shows a state in which a viewer is viewing a three-dimensional image on a display screen.

FIG. 26 shows an arrangement of cameras set within a three-dimensional image processing apparatus.

FIG. 27 shows how a viewer is viewing a parallax image obtained with the camera placement shown in FIG. 26.

FIG. 28 shows how a viewer at a position of the viewer shown in FIG. 25 is viewing on a display screen an image whose appropriate parallax has been obtained at the camera placement of FIG. 26.

FIG. 29 shows a state in which a nearest-position point of a sphere positioned at a distance of A from a display screen is shot from a camera placement shown in FIG. 26.

FIG. 30 shows a relationship among two cameras, optical axis tolerance distance of camera and camera interval required to obtain parallax shown in FIG. 29.

FIG. 31 shows a state in which a farthest-position point of a sphere positioned at a distance of T-A from a display screen is shot from a camera placement shown in FIG. 26.

FIG. 32 shows a relationship among two cameras, optical axis tolerance distance of camera and camera interval E2 required to obtain parallax shown in FIG. 31.

FIG. 33 shows a relationship among camera parameters necessary for setting the parallax of a 3D image within an appropriate parallax range.

FIG. 34 shows another relationship among camera parameters necessary for setting the parallax of a 3D image within an appropriate parallax range.

FIG. 35 illustrates a structure of a three-dimensional image processing apparatus according to a ninth embodiment of the present invention.

FIG. 36 illustrates how the combined view volume is created by using preferentially a farther-positioned maximum parallax amount.

FIG. 37 illustrates a third relationship between values in the Z′-axis direction and those in the Z-axis direction in a compression processing.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

The three-dimensional image processing apparatuses to be hereinbelow described in the first to ninth embodiments of the present invention are each an apparatus for generating parallax images, which are a plurality of two-dimensional images and which serve as base points of 3D display, from a plurality of different viewpoints. By producing such images on a 3D image display unit or the like, such an apparatus realizes a 3D image representation providing impressive and vivid 3D images with objects therein flying out toward a user. For example, in a racing game, a player can enjoy a 3D game in which the player operates an object, such as a car, displayed right before his/her eyes and has it run within an object space in competition with the other cars operated by the other players or the computer.

When two-dimensional images are to be generated for a plurality of viewpoints, for instance, two two-dimensional images for two cameras (hereinafter referred to simply as “real cameras”), this apparatus first positions a camera (hereinafter referred to simply as “temporary camera”) in a virtual three-dimensional space. Then, in reference to the temporary camera, a single view volume, or a combined view volume, which contains the view volumes defined by the real cameras, respectively, is generated. A view volume, as is commonly known, is a space clipped by a front clipping plane and a back clipping plane. And an object existing within this space is finally taken into two-dimensional images before they are displayed three-dimensionally. The above-mentioned real cameras are used to generate two-dimensional images, whereas the temporary camera is used to simply generate a combined view volume.

After the generation of a combined view volume, this apparatus acquires the view volumes for the real cameras, respectively, by performing a coordinate conversion using a transformation matrix to be discussed later on the combined view volume. Finally, the two view volumes obtained for the respective real cameras are projected onto a projection plane so as to generate two-dimensional images. In this manner, two two-dimensional images, which serve as base points for a parallax image, can be generated by a temporary camera by acquiring view volumes for the respective real cameras from a combined view volume. As a result, the process for actually placing real cameras in a virtual three-dimensional space can be eliminated, thus providing a great advantage particularly when a large number of cameras are to be placed. Hereinbelow, the first to third embodiments represent coordinate conversion using a skew transform, and the fourth to sixth represent coordinate conversion using a rotational transformation.

### FIRST EMBODIMENT

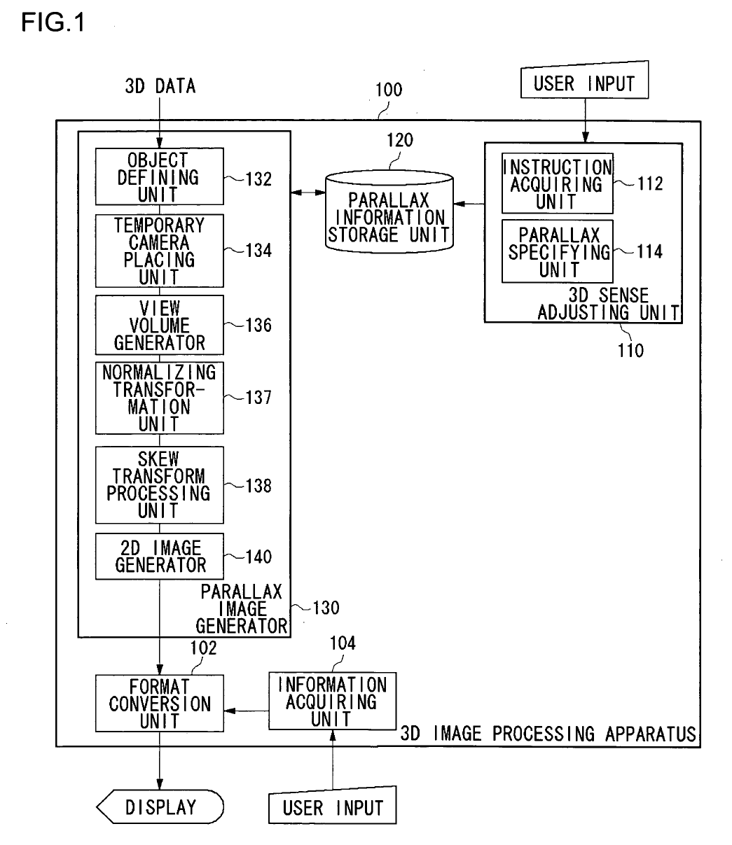

FIG. 1 illustrates a structure of a three-dimensional image processing apparatus 100 according to a first embodiment of the present invention. This three-dimensional image processing apparatus 100 includes a three-dimensional sense adjusting unit 110 which adjusts the three-dimensional effect and sense according to a user response to an image displayed three-dimensionally, a parallax information storage unit 120 which stores an appropriate parallax specified by the three-dimensional sense adjusting unit 110, a parallax image generator 130 which generates a plurality of two-dimensional images, namely, parallax images, by placing a temporary camera, generating a combined view volume in reference to the temporary camera and appropriate parallax and projecting onto a projection plane view volumes resulting from a skew transform processing performed on the combined view volume, an information acquiring unit 104 which has a function of acquiring hardware information on a display unit and also acquiring a stereo display scheme, and a format conversion unit 102 which changes the format of the parallax image generated by the parallax image generator 130 based on the information acquired by the information acquiring unit 104. The 3D data for rendering the objects and virtual three-dimensional space on a computer are inputted to the three-dimensional image processing apparatus 100.

In terms of hardware, the above-described structure can be realized by a CPU, a memory and other LSIs of an arbitrary computer, whereas in terms of software, it can be realized by programs which have GUI function, parallax image generating function and other functions or the like, but drawn and described here are function blocks that are realized in cooperation with those. Thus, it is understood by those skilled in the art that these function blocks can be realized in a variety of forms such as hardware only, software only or combination thereof, and the same is true as to the structure in what is to follow.

The three-dimensional sense adjusting unit 110 includes an instruction acquiring unit 112 and a parallax specifying unit 114. The instruction acquiring unit 112 acquires an instruction when it is given by the user who specifies a range of appropriate parallax in response to an image displayed three-dimensionally. Based on this range of appropriate parallax, the parallax specifying unit 114 identifies the appropriate parallax when the user uses this display unit. The appropriate parallax is expressed in a format that does not depend on the hardware of a display unit. And stereo vision matching the physiology of the user can be achieved by realizing the appropriate parallax. The specification of a range of appropriate parallax by the user as described above is accomplished via a GUI (Graphical User Interface), not shown, the detail of which will be discussed later.

The parallax image generator 130 includes an object defining unit 132, a temporary camera placing unit 134, a view volume generator 136, a normalizing transformation unit 137, a skew transform processing unit 138 and a two-dimensional image generator 140. The object defining unit 132 converts data on an object defined by a modeling-coordinate system into that of a world-coordinate system. The modeling-coordinate system is a coordinate space that each of individual objects owns. On the other hand, the world-coordinate system is a coordinate space that a virtual three-dimensional space owns. By carrying out such a coordinate conversion as above, the object defining unit 132 can place the objects in the virtual three-dimensional space.

The temporary camera placing unit 134 temporarily places a single temporary camera in a virtual three-dimensional space, and determines the position and sight-line direction of the temporary camera. The temporary camera placing unit 134 carries out affine transformation so that the temporary camera lies at the origin of a viewpoint-coordinate system and the sight-line direction of the temporary camera is in the depth direction, that is, it is oriented in the positive direction of Z axis. The data on objects in the world-coordinate system is coordinate-converted to the data in the viewpoint-coordinate system of the temporary camera. This conversion processing is called a viewing transformation.

Based on the temporary camera placed by the temporary camera placing unit 134 and the appropriate parallax stored in the parallax information storage unit 120, the view volume generator 136 generates a combined view volume which contains the view volumes defined by the two real cameras, respectively. The positions of the front clipping plane and the back clipping plane of a combined view volume are determined using the z-buffer method which is a known algorithm of hidden surface removal. The z-buffer method is a technique such that when the z-values of an object are to be stored for each pixel, the z-value already stored is overwritten by any z-value closer to the viewpoint on the Z axis. The range of combined view volume is specified by obtaining the maximum z-value and the minimum z-value among the z-values thus stored for each pixel (hereinafter referred to simply as “maximum z-value” and “minimum z-value”, respectively). A concrete method for specifying the range of combined view volume using the appropriate parallax, maximum z-value and minimum z-value will be discussed later.

The z-buffer method is normally used when the two-dimensional image generator 140 generates two dimensional images in a post-processing. Thus, when the combined view volume is generated, both the maximum z-value and the minimum z-value are not available. Hence, in the frame immediately before a current frame the view volume generator 136 determines the positions of the front clipping plane and the back clipping plane of the current frame, using the maximum z-value and the minimum z-value obtained when the two-dimensional images were generated.

As is commonly known, in the z-buffer method a visible-surface area to be three-dimensionally displayed is detected. That is, a hidden-surface area which is an invisible surface is detected and then the detected hidden-surface area is eliminated from what is to be 3D displayed. The visible-surface area detected by using the z-buffer method serves as the range of combined view volume and the hidden area that the user cannot view in the first place is eliminated from said range, so that the range of combined view volume can be optimized.

The normalizing transformation unit 137 transforms the combined view volume generated by the view volume generator 136 into a normalized coordinate system. This transform processing is called the normalizing transformation. The skew transform processing unit 138 derives a skewing transformation matrix after the normalizing transformation has been carried out by the normalizing transformation unit 137. And by applying the thus derived skewing transformation matrix to the combined view volume, the skew transform processing unit 138 acquires a view volume for each of the real cameras. The detailed description of such processings will be given later.

The two-dimension image generator 140 projects the view volume per real camera into a screen surface. After the projection, the two-dimensional image drawn onto said screen surface is converted into a region specified in a display-device-specific screen-coordinate system, namely, a viewport. The screen-coordinate system is a coordinate system used to represent the positions of pixels in an image and is the same as the coordinate system in a two-dimensional image. As a result of such a processing, the two-dimensional image having appropriate parallaxes for each of the real cameras is generated and the parallax images are finally created. By realizing the appropriate parallaxes, the stereo vision matching the physiology of the user can be achieved.

The information acquiring unit 104 acquires information which is inputted by the user. The “information” includes the number of viewpoints for 3D display, the system of a stereo display apparatus such as space division or time division, whether shutter glasses are used or not, the arrangement of two-dimensional images in the case of a multiple-eye system and whether there is any arrangement of two-dimensional images with inverted parallax among the parallax images.

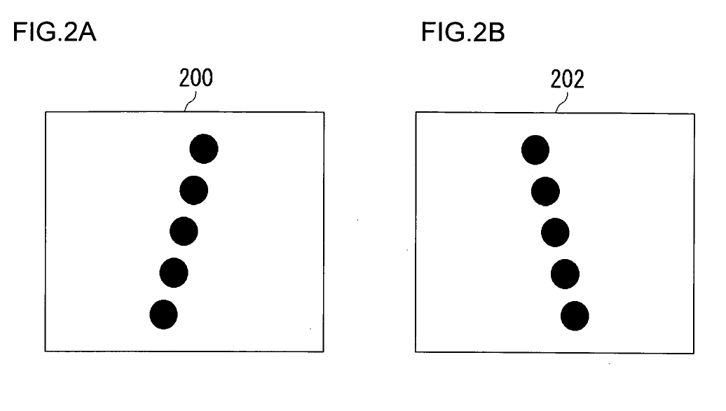

FIG. 2 to FIG. 4 illustrate how a user specifies the range of approximate parallax. FIG. 2A and FIG. 2B show respectively a left-eye image 200 and a right-eye image 202 displayed in a certain process of appropriate parallax by a three-dimensional sense adjusting unit 110 of a three-dimensional image processing apparatus 100. The images shown in FIG. 2A and FIG. 2B each display five black circles, for which the higher the position, the nearer the placement and the greater the parallax is, and the lower the position, the farther the placement and the greater the parallax is. The “parallax” is a parameter to produce a stereoscopic effect and various definitions are possible. In the present embodiments, it is represented by a difference between coordinates values that represent the same position among two-dimensional images.

Being “nearer-positioned” means a state where there is given a parallax in a manner such that stereovision is done in front of a surface (hereinafter referred to as “optical axis intersecting surface” also) at a sight line of two cameras placed at different positions, namely, at an intersecting position of optical axes (hereinafter referred to as “optical axis intersecting position” also). Conversely, being “farther-positioned” means a state where there is given a parallax in a manner such that stereovision is done behind the optical axis intersecting surface. The larger the parallax of a nearer-positioned object, it is perceived closer to a user whereas the larger the parallax of a farther-positioned object, it is seen farther from the user. Unless otherwise stated, the parallax is such that a plus and a minus do not invert around by between nearer position and farther position and both the positions are defined as nonnegative values and the nearer-positioned parallax and the farther-positioned parallax are both zeroes at the optical axis intersecting surface.

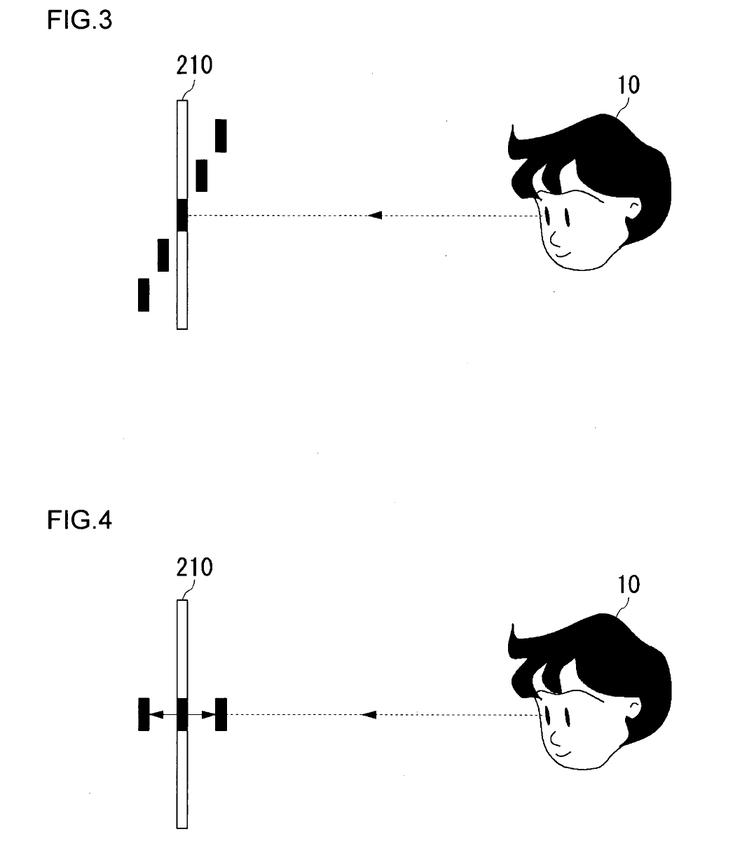

FIG. 3 shows schematically a sense of distance perceived by a user 10 when these five black circles are displayed on a screen surface 210. In FIG. 3, the five black circles with different parallaxes are displayed all at once or one by one, and the user 10 performs inputs indicating whether the parallax is permissible or not. In FIG. 4, on the other hand, the display on the screen surface 210 is done in a single black circle, whose parallax is changed continuously. When the parallax reaches a permissible limit in each of the farther and the nearer placement direction, a predetermined input instruction from a user 10 is given, so that an allowable parallax can be determined. The instruction may be given using any known technology, which includes ordinary key operation, mouse operation, voice input and so forth.

In both cases of FIG. 3 and FIG. 4, the instruction acquiring unit 112 can acquire an appropriate parallax as a range thereof, so that the limit parallaxes on the nearer-position side and the farther-position side are determined. The limit parallax on the nearer-position side is called a nearer-positioned maximum parallax whereas the limit parallax on the farther-position side is called a farther-positioned maximum parallax. The nearer-positioned maximum parallax is a parallax corresponding to the closeness which the user permits for a point perceived closest to himself/herself, and the farther-positioned maximum parallax is a parallax corresponding to the distance which the user permits for a point perceived farthest from himself/herself. Generally, however, the nearer-positioned maximum parallax is more important to the user for physiological reasons, and therefore the nearer-positioned maximum parallax only may sometimes be called the limit parallax hereinbelow.

Once the appropriate parallax has been acquired within the three-dimensional image processing apparatus 100, the same appropriate parallax is also realized in displaying later the other images three dimensionally. The user may adjust the parallax of the currently displayed image. A predetermined appropriate parallax may be given beforehand to the three-dimensional image processing apparatus 100.

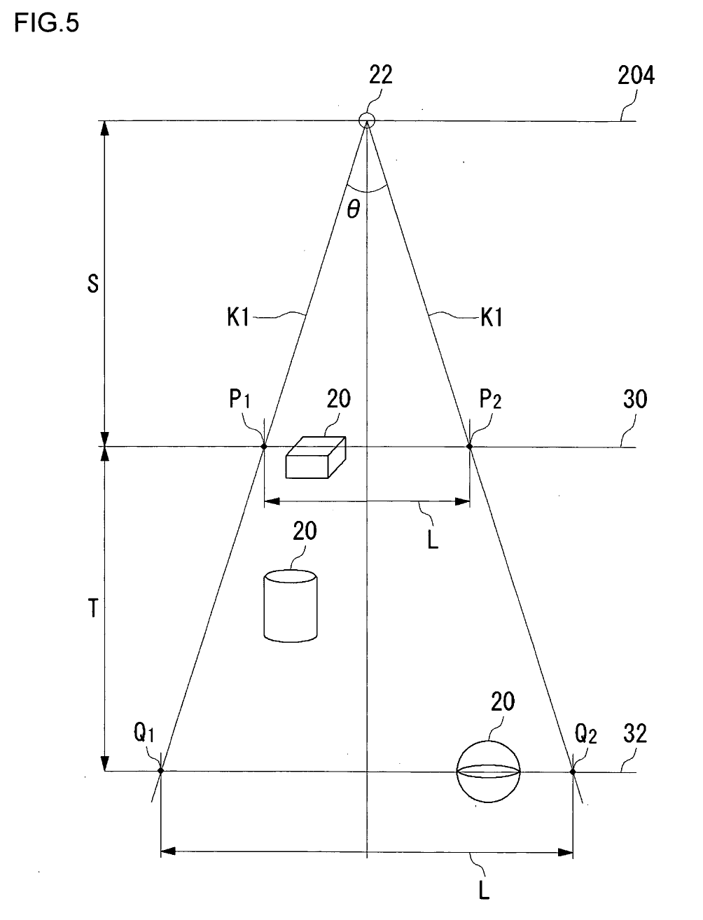

FIG. 5 to FIG. 11 illustrate how a three-dimensional image processing apparatus 100 generates a combined view volume in reference to a temporary camera, placed by a temporary camera placing unit 134, and appropriate parallax and acquires view volumes for real cameras by having a skew transform processing performed on the combined view volume. FIG. 5 illustrates the relationship between the angle of view θ of a temporary camera 22 and the number of pixels L in the horizontal direction of two-dimensional images to be generated finally. The angle of view θ is an angle subtended at the temporary camera 22 by an object placed within the virtual three-dimensional space. In this illustration, the X axis is placed in the right direction, the Y axis in the upper direction, and the Z axis in the depth direction as seen from the temporary camera 22.

An object 20 is placed by an object defining unit 132, and the temporary camera 22 is placed by the temporary camera placing unit 134. The aforementioned front clipping plane and back clipping plane correspond to a frontmost object plane 30 and a rearmost object plane 32, respectively, in FIG. 5. The space defined by the front object plane 30 as the front plane, the rear object plane 32 as the rear plane and first lines of sight K1 as the boundary lines is the view volume of the temporary camera (hereinafter referred to simply as “finally used region”), and the objects contained in this space are taken into two-dimensional images finally. The range in the depth direction of the finally used region is denoted by T.

As hereinbefore described, a view volume generator 136 determines the positions of the front object plane 30 and the rear object plane 32, using a known algorithm of hidden surface removal which is called the z-buffer method. More specifically, the view volume generator 136 determines the distance (hereinafter referred to simply as “viewpoint distance”) S from the plane 204 where the temporary camera 22 is placed (hereinafter referred to simply as “viewpoint plane”) to the frontmost object plane 30, using a minimum z-value. The view volume generator 136 also determines the distance from the viewpoint plane 204 to the rearmost object plane 32, using a maximum z-value. Since it is not necessary to strictly define the range of the finally used region, the view volume generator 136 may determine the positions of the front object plane 30 and the rear object plane 32 using a value near the minimum z-value and a value near the maximum z-value. To ensure that the view volume covers all the visible parts of objects with greater certainty, the view volume generator 136 may determine the positions of the front object plane 30 and the rear object plane 32 using a value slightly smaller than the minimum z-value and a value slightly larger than the maximum z-value.

The positions where the first lines of sight K1, delineating the angle of view θ from the temporary camera 22, intersect with the front object plane 30 are denoted by a first front intersecting point P₁ and a second front intersecting point P₂, respectively, and the positions where the first lines of sight K1 intersect with the rear object plane 32 are denoted by a first rear intersecting point Q₁ and a second rear intersecting point Q₂, respectively. Here, the interval between the first front intersecting point P₁ and the second front intersecting point P₂ and the interval between the first rear intersecting point Q₁ and the second rear intersecting point Q₂ correspond to their respective numbers of pixels L in the horizontal direction of the two-dimensional images to be generated finally. The space surrounded by the first front intersecting point P₁, the first rear intersecting point Q₁, the second rear intersecting point Q₂ and the second front intersecting point P₂ is the finally used region mentioned earlier.

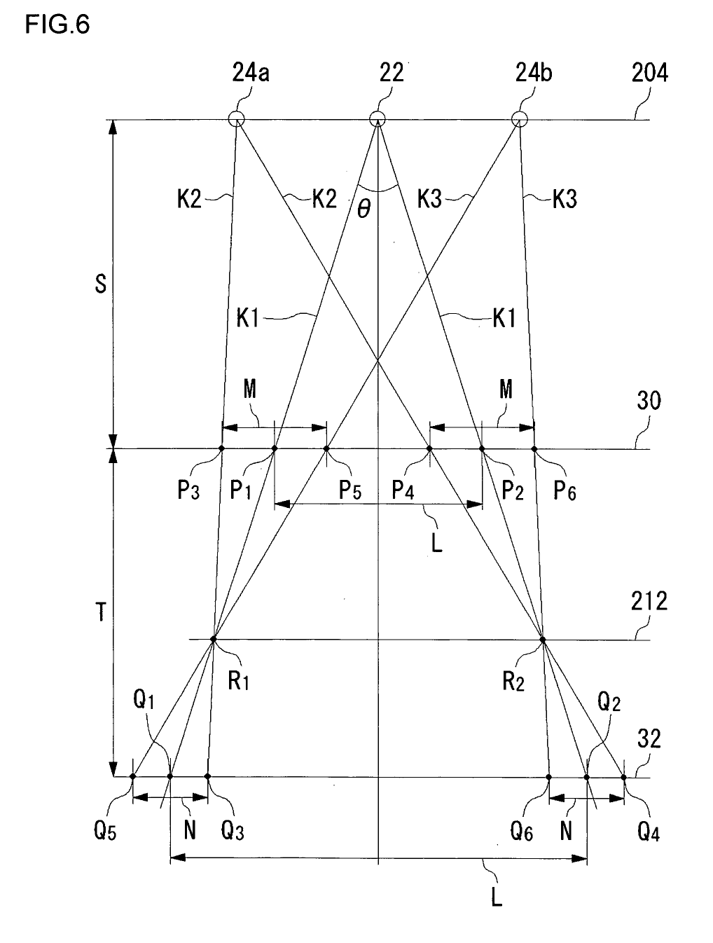

FIG. 6 illustrates a nearer-positioned maximum parallax amount M and a farther-positioned maximum parallax amount N in a virtual three-dimensional space. The same references found in FIG. 5 are indicated by the same reference symbols and their repeated explanation is omitted as appropriate. As described earlier, the nearer-positioned maximum parallax amount M and the farther-positioned maximum parallax amount N are specified by the user via a three-dimensional sense adjusting unit 110. The positions of a real right-eye camera 24a and a real left-eye camera 24b on a viewpoint plane 204 are determined by the nearer-positioned maximum parallax amount M and the farther-positioned maximum parallax amount N thus specified. However, for a reason to be discussed later, when the nearer-positioned maximum parallax amount M and the farther-positioned maximum parallax amount N are already decided, the respective view volumes for real cameras 24 may be acquired from the combined view volume of a temporary camera 22 without actually placing the real cameras 24.

The positions where the second lines of sight K2 from the real right-eye camera 24a intersect with the front object plane 30 are denoted by a third front intersecting point P₃ and a fourth front intersecting point P₄, respectively, and the positions where the second lines of sight K2 intersect with the rear object plane 32 are denoted by a third rear intersecting point Q₃ and a fourth rear intersecting point Q₄, respectively. In the same way, the positions where the third lines of sight K3 from the real left-eye camera 24b intersect with the front object plane 30 are denoted by a fifth front intersecting point P₅ and a sixth front intersecting point P₆, respectively, and the positions where the third lines of sight K3 intersect with the rear object plane 32 are denoted by a fifth rear intersecting point Q₅ and a sixth rear intersecting point Q₆, respectively.

A view volume defined by the real right-eye camera 24a is a region (hereinafter referred to simply as “right-eye view volume”) delineated by the third front intersecting point P₃, the third rear intersecting point Q₃, the fourth rear intersecting point Q₄ and the fourth front intersecting point P₄. On the other hand, a view volume defined by the real left-eye camera 24b is a region (hereinafter referred to simply as “left-eye view volume”) delineated by the fifth front intersecting point P₅, the fifth rear intersecting point Q₅, the sixth rear intersecting point Q₆ and the sixth front intersecting point P₆. A combined view volume defined by the temporary camera 22 is a region delineated by the third front intersecting point P₃, the fifth rear intersecting point Q₅, the fourth rear intersecting point Q₄ and the sixth front intersecting point P₆. As shown in FIG. 6, the combined view volume includes both the right-eye view volume and left-eye view volume.

Here, the amount of mutual displacement in the horizontal direction of the field of view ranges of the real right-eye camera 24a and the real left-eye camera 24b at the frontmost object plane 30 corresponds to the nearer-positioned maximum parallax amount M, which is determined by the user through the aforementioned three-dimensional sense adjusting unit 110. More specifically, the interval between the third front intersecting point P₃ and the fifth front intersecting point P₅ and the interval between the fourth front intersecting point P₄ and the sixth front intersecting point P₆ correspond each to the nearer-positioned maximum parallax amount M. In a similar manner, the amount of mutual displacement in the horizontal direction of the field of view ranges of the real right-eye camera 24a and the real left-eye camera 24b at the rearmost object plane 32 corresponds to the farther-positioned maximum parallax amount N, which is determined by the user through the aforementioned three-dimensional sense adjusting unit 110. More specifically, the interval between the third rear intersecting point Q₃ and the fifth rear intersecting point Q₅ and the interval between the fourth rear intersecting point Q₄ and the sixth rear intersecting point Q₆ correspond each to the farther-positioned maximum parallax amount N.

With the nearer-positioned maximum parallax amount M and the farther-positioned maximum parallax amount N specified, the position of an optical axis intersecting plane 212 is determined. That is, the optical axis intersecting plane 212, which corresponds to a screen surface as discussed earlier, is a plane in which lies a first optical axis intersecting point R₁ where the line segment joining the third front intersecting point P₃ and the third rear intersecting point Q₃ intersects with the line segment joining the fifth front intersecting point P₅ and the fifth rear intersecting point Q₅. Also resides in this screen surface is a second optical axis intersecting point R₂ where the line segment joining the fourth front intersecting point P₄ and the fourth rear intersecting point Q₄ intersects with the line segment joining the sixth front intersecting point P₆ and the sixth rear intersecting point Q₆. The screen surface is also equal to a projection plane where objects in the view volume are projected and finally taken into two-dimensional images.

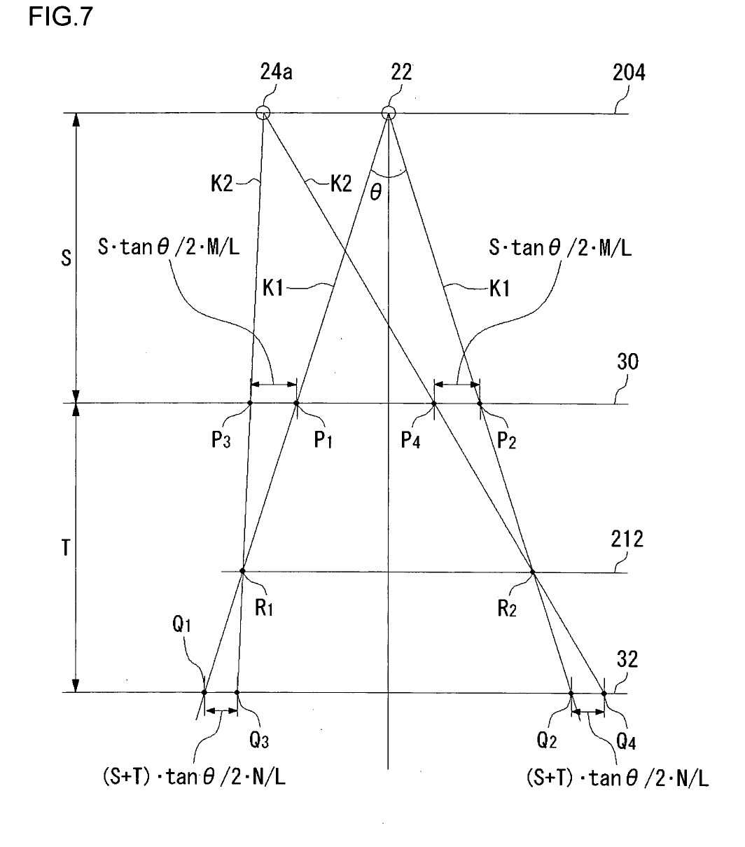

FIG. 7 illustrates a representation of the amount of displacement in the horizontal direction in units in a virtual three-dimensional space. If the interval between a first front intersecting point P₁ and a third front intersecting point P₃ is designated as a first horizontal displacement amount d₁ and the interval between a first rear intersecting point Q₁ and a third rear intersecting point Q₃ as a second horizontal displacement amount d₂, then the first horizontal displacement amount d₁ and the second horizontal displacement amount d₂ correspond to M/2 and N/2, respectively. Hence,
d₁:Stan(θ/2)=M/2:L/2
d₂:(S+T)tan(θ/2)=M/2:L/2
Therefore, the first horizontal displacement amount d₁ and the second horizontal displacement amount d₂ are expressed as
d₁=SM tan(θ/2)/L
d₂=(S+T)N tan(θ/2)/L

As described above, the nearer-positioned maximum parallax amount M and the farther-positioned maximum parallax amount N are determined by the user through the three-dimensional sense adjusting unit 110, and the extent T of a finally used region and the viewpoint distance S are determined from the maximum z-value and the minimum z-value. Once the nearer-positioned maximum parallax amount M and the farther-positioned maximum parallax amount N are taken into the three-dimensional image processing apparatus 100, the first horizontal displacement amount d₁ and the second horizontal displacement amount d₂ can be determined, so that a combined view volume can be obtained from a temporary camera 22 without actually placing two real cameras 24a and 24b.

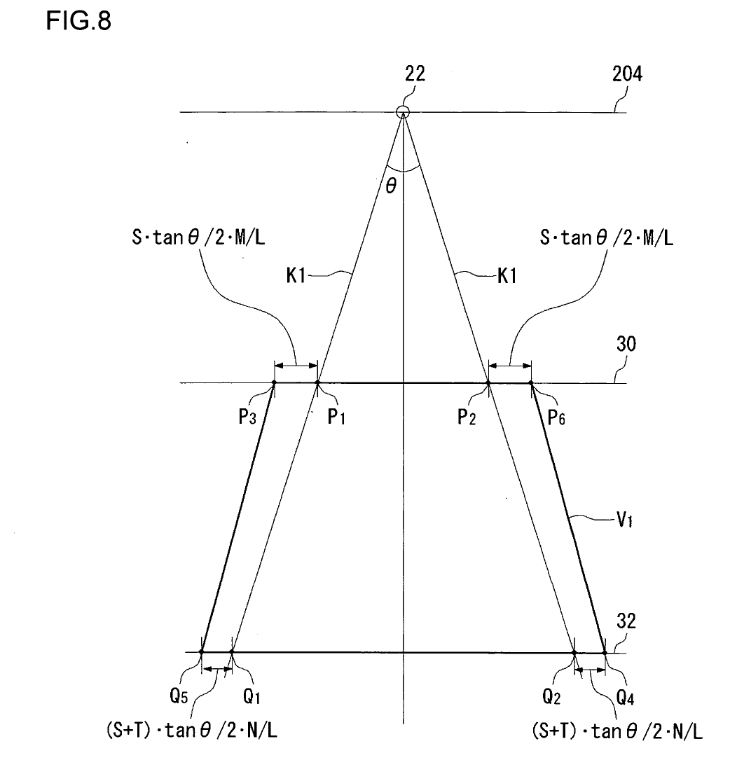

FIG. 8 illustrates how a combined view volume V₁ is generated based on a first horizontal displacement amount d₁ and a second horizontal displacement amount d₂. The view volume generator 136 designates the points on a frontmost object plane 30, which are each shifted outward in the horizontal direction by the first horizontal displacement amount d₁ from a first front intersecting point P₁ and a second front intersecting point P₂, as a third front intersecting point P₃ and a sixth front intersecting point P₆, respectively. It also designates the points on a rearmost object plane 32, which are each shifted outward in the horizontal direction by the second horizontal displacement amount d₂ from a first rear intersecting point Q₁ and a second rear intersecting point Q₂, as a fifth rear intersecting point Q₅ and a fourth rear intersecting point Q₄, respectively. The view volume generator 136 may determine the region delineated by the thus obtained third front intersecting point P₃, fifth rear intersecting point Q₅, fourth rear intersecting point Q₄ and sixth front intersecting point P₆ as the combined view volume V₁.

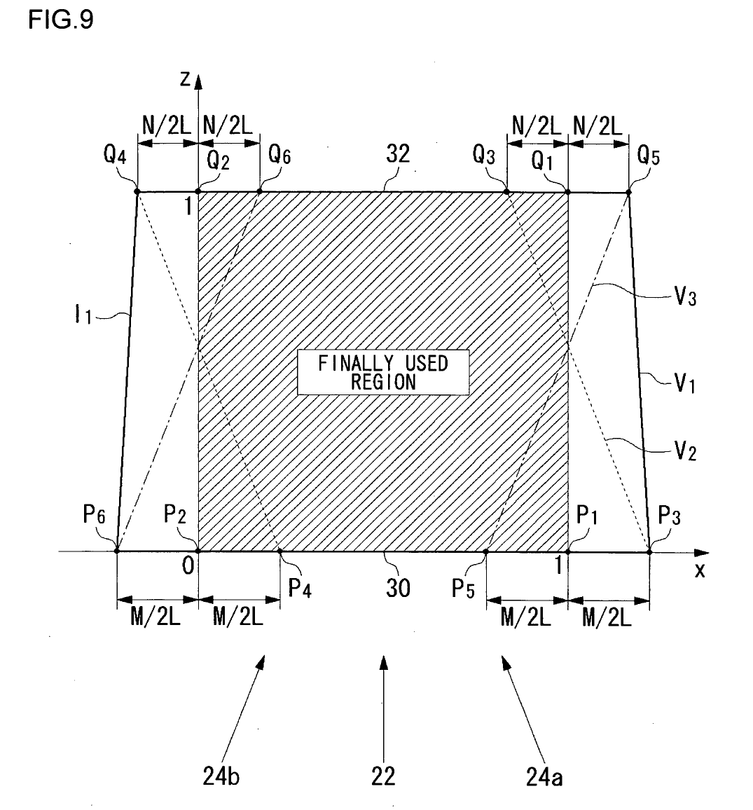

FIG. 9 illustrates a relationship among a combined view volume V₁, a right-eye view volume V₂ and a left-eye view volume V₃ after normalizing transformation. The vertical axis is the Z axis, and the horizontal axis is the X axis. As shown in FIG. 9, the combined view volume V₁, of a temporary camera 22 is transformed into a normalized coordinate system by a normalizing transformation unit 137. The region delineated by a sixth front intersecting point P₆, a third front intersecting point P₃, a fifth rear intersecting point Q₅ and a fourth rear intersecting point Q₄ corresponds to the combined view volume V₁. The region delineated by a fourth front intersecting point P₄, a third front intersecting point P₃, a third rear intersecting point Q₃ and a fourth rear intersecting point Q₄ corresponds to the right-eye view volume V₂ determined by the real right-eye camera 24a. The region delineated by a sixth front intersecting point P₆, a fifth front intersecting point P₅, a fifth rear intersecting point Q₅ and a sixth rear intersecting point Q₆ corresponds to the left-eye view volume V₃ determined by the real left-eye camera 24b. The region delineated by a first front intersecting point P₁, a second front intersecting point P₂, a second rear intersecting point Q₂ and a first rear intersecting point Q₁ is the finally used region, and the data on the objects in this region is converted finally into data on two-dimensional images.

Since there is no agreement in the direction of the lines of sight of the temporary camera 22 and the real cameras 24 as shown in FIG. 9, the right-eye view volume V₂ and the left-eye view volume V₃ are each not in agreement with the finally used region of the temporary camera 22. Hence, a skew transform processing unit 138 brings the right-eye view volume V₂ and the left-eye view volume V₃ into agreement with the finally used region by applying a skewing transformation matrix to be discussed later to the combined view volume V₁. Here, a first line segment l₁ joining the sixth front intersecting point P₆ and the fourth rear intersecting point Q₄ is defined as Z=aX+b, where a and b are constants to be determined by the positions of the sixth front intersecting point P₆ and the fourth rear intersecting point Q₄. This first line segment l₁ is used when deriving a skewing transformation matrix discussed later.

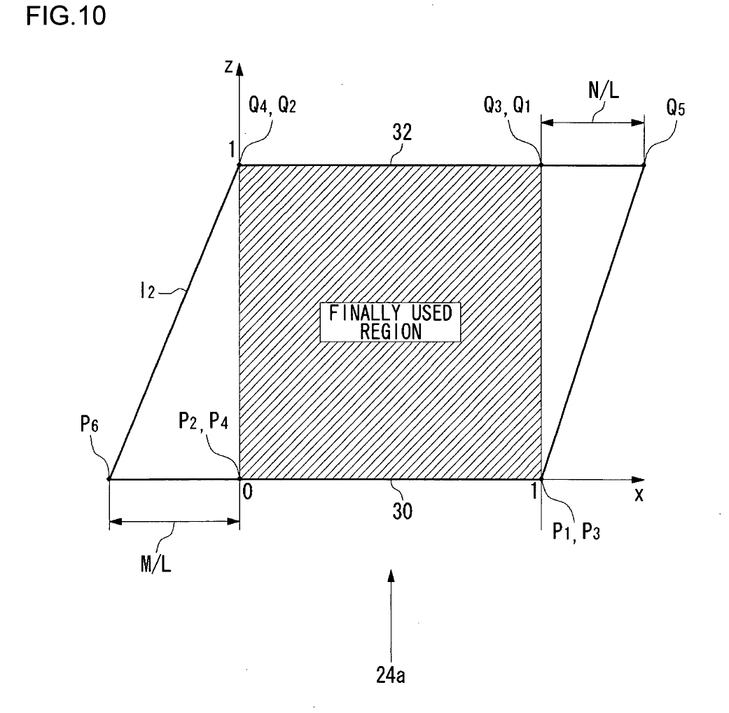

FIG. 10 illustrates a right-eye view volume V₂ after a skew transform processing. A skewing transformation matrix is derived as described below. A second line segment l₂ joining the sixth front intersecting point P₆ and the fourth rear intersecting point Q₄ is defined as Z=cX+d, where c and d are constants to be determined by the sixth front intersecting point P₆ and the fourth rear intersecting point Q₄ after a skew transform processing. The coordinates ((Z-b)/a, Y, Z) of a point on the above-mentioned first line segment l1 are transformed into the coordinates ((Z-d)/c, Y, Z) of a point on the second line segment i₂. At this time, the coordinates (X₀, Y₀, Z₀) within the combined view volume V₁ are transformed into the coordinates (X₁, Y₁, Z₁), and therefore the transformation equations are expressed as
X₁=X₀+{(Z₀-d)/c-(Z₀-b)/a}
X₀+(1/c-1/a)Z₀+(b/a-d/c)
=X₀+AZ₀+B
X₁=Y₀
Z₁=Z₀
where A:=1/c-1/a and B:=b/a-d/c.

Accordingly, the skewing transformation matrix is be written

$$( \begin{matrix}{X}_{1} \\ {Y}_{1} \\ {Z}_{1} \\ 1\end{matrix} ) = ( \begin{matrix}1 & 0 & A & B \\ 0 & 1 & 0 & 0 \\ 0 & 0 & 1 & 0 \\ 0 & 0 & 0 & 1\end{matrix} ) ( \begin{matrix}{X}_{0} \\ {Y}_{0} \\ {Z}_{0} \\ 1\end{matrix} ) \qquad ( Equation 1 )$$

As a result of the skew transform processing using the above-described skewing transformation matrix, the fourth front intersecting point P₄ coincides with the second front intersecting point P₂, the third front intersecting point P₃ with the first front intersecting point P₁, the third rear intersecting point Q₃ with the first rear intersecting point Q₁, and the fourth rear intersecting point Q₄ with the second rear intersecting point Q₂, and consequently the right-eye view volume V₂ coincides with the finally used region. The two-dimensional image generator 140 generates two-dimensional images by projecting this finally used region on a screen surface. A skew transform processing similar to the one for the right-eye view volume V₂ is also carried out for the left-eye view volume V₃.

In this manner, two two-dimensional images, which serve as base points for a parallax image, can be generated by a temporary camera only by acquiring view volumes for the respective real cameras through the skewing transformation performed on the combined view volume. As a result, the process for actually placing real cameras in a virtual three-dimensional space can be eliminated, thus realizing a high-speed three-dimensional image processing as a whole. This provides a great advantage particularly when there are a large number of real cameras to be placed.

When generating a single combined view volume, it is enough for the three-dimensional image processing apparatus 100 to place a single temporary camera, so that only one time of viewing transformation is required for the placement of a temporary camera by the temporary camera placing unit 134. The coordinate conversion of viewing transform must cover the entire data on the objects defined within the virtual three-dimensional space. The entire data includes not only the data on the objects to be finally taken into two-dimensional images but also the data on the objects which are not to be finally taken into two-dimensional images. According to the present embodiment, the use of only one time of viewing transform shortens the time for transformation by reducing the number of coordinate transformations for the data on the objects which are not finally taken into two-dimensional images. This realizes a more efficient three-dimensional image processing. The more the volume of data on the objects which are not finally taken into two-dimensional images or the greater the number of real cameras to be placed, the greater the positive effect will be.

After the generation of a combined view volume, a new skew transform processing is carried out. However, data to be processed is limited to the data on the objects, within the combined view volume, to be finally taken into two-dimensional images, so that the amount of data to be processed is smaller than the amount of data to be processed at a viewing transform, which covers all the objects within the virtual three-dimensional space. Hence, the processing, as a whole, for three-dimensional display can be realized at high speed.

A single temporary camera may be used for the purpose of the present embodiment. The reason is that whereas real cameras are used to generate parallax images, the temporary camera is used only to generate a combined view volume. That is sufficient as the role of the temporary camera. Hence, while it is possible to use a plurality of temporary cameras to generate a plurality of combined view volumes, use of a single temporary camera will ensure a speedy acquisition of view volumes determined by the respective real cameras.

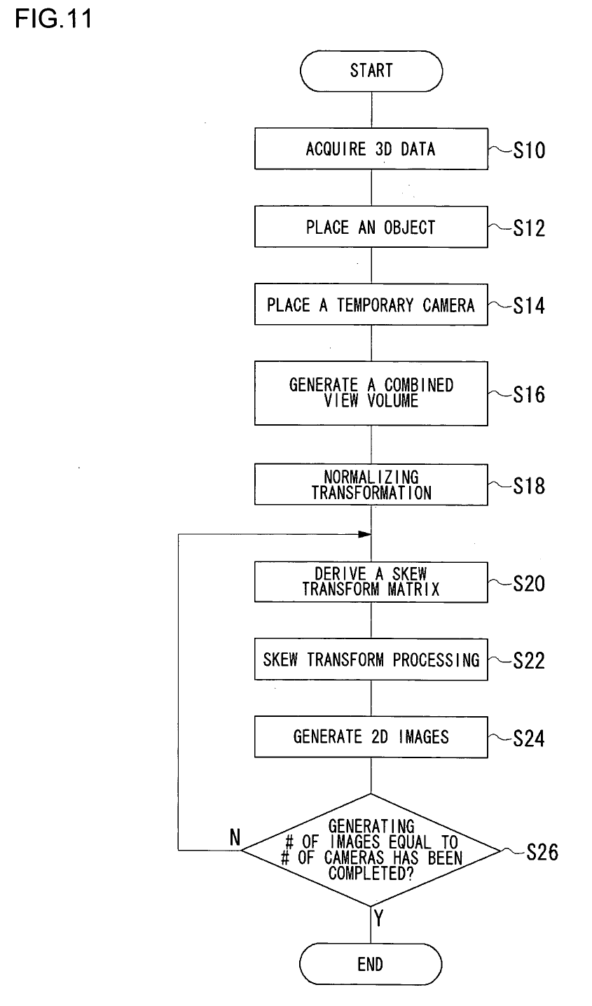

FIG. 11 is a flowchart showing the processing to generate a parallax image. This processing is repeated for each frame. The three-dimensional image processing apparatus 100 acquires three-dimensional data (S10). The object defining unit 132 places objects in a virtual three-dimensional space based on the three-dimensional data acquired by the three-dimensional image processing apparatus 100 (S12). The temporary camera placing unit 134 places a temporary camera within the virtual three-dimensional space (S14). After the placement of the temporary camera by the temporary camera placing unit 134, the view volume generator 136 generates the combined view volume V₁ by deriving the first horizontal displacement amount d₁ and a second horizontal displacement amount d₂ (S16).

The normalizing transformation unit 137 transforms the combined view volume V₁ into a normalized coordinate system (S18). The skew transform processing unit 138 derives a skewing transformation matrix (S20) and performs a skew transform processing on the combined view volume V₁ based on the thus derived skewing transformation matrix and thereby acquires view volumes to be determined by real cameras 24 (S22). The two-dimensional image generator 140 generates a plurality of two-dimensional images, namely, parallax images, by projecting the respective view volumes of the real cameras on the screen surface (S24). When the number of two-dimensional images equal to the number of the real cameras 24 has not been generated (N of S26), the processing from the derivation of a skewing transformation matrix on is repeated. When the number of two-dimensional images equal to the number of the real cameras 24 has been generated (Y of S26), the processing for a frame is completed.

### SECOND EMBODIMENT

A second embodiment of the present invention differs from the first embodiment in that a three-dimensional image processing apparatus 100 generates a combined view volume by increasing the viewing angle of a temporary camera. Such a processing can be realized by a similar structure to that of the three-dimensional image processing apparatus 100 shown in FIG. 1. However, according to the second embodiment, a view volume generator 136 further has a function of generating a combined view volume by increasing the viewing angle of the temporary camera. Also, a two-dimensional image generator 140 further has a function of acquiring two-dimensional images by increasing the number of pixels in the horizontal direction according to the increased viewing angle of the temporary camera and cutting out two-dimensional images for the number of pixels L in the horizontal direction, which corresponds to a finally used region, from the two-dimensional images. The extent of increase in the number of pixels in the horizontal direction will be described later.

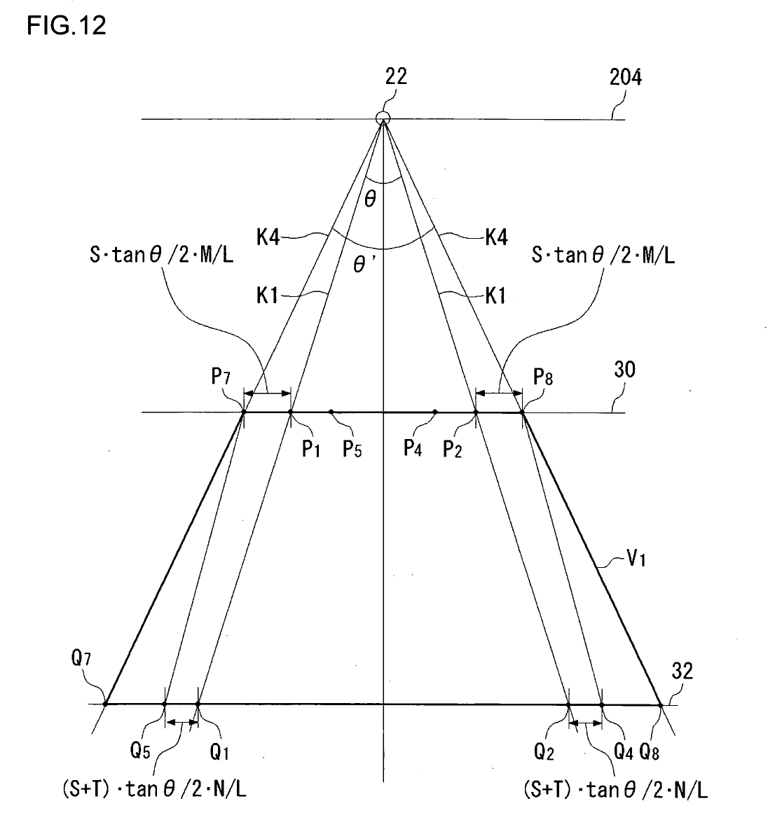

FIG. 12 illustrates how a combined view volume V₁ is generated by increasing the viewing angle θ of a temporary camera. The same reference numbers are used for the same parts as in FIG. 6 and their repeated explanation will be omitted as appropriate. The viewing angle from the temporary camera 22 is increased from θ to θ′ by the view volume generator 136. The positions where the fourth lines of sight K4, delineating the viewing angle θ′ from the temporary camera 22, intersect with a frontmost object plane 30 are denoted by a seventh front intersecting point P₇ and an eighth front intersecting point P₈, respectively, and the positions where the fourth lines of sight K4 intersect with a rearmost object plane 32 are denoted by a seventh rear intersecting point Q₇ and an eighth rear intersecting point Q₈, respectively. Here, the seventh front intersecting point P₇ and the eighth front intersecting point P₈ correspond to and are identical to the aforementioned third front intersecting point P₃ and sixth front intersecting point P₆, respectively. Depending on the values of a first horizontal displacement amount d₁ and a second horizontal displacement amount d₂, there may be cases where the seventh rear intersecting point Q₇ and the eighth rear intersecting point Q₈ correspond to and are identical to the aforementioned fifth rear intersecting point Q₅ and fourth rear intersecting point Q₄, respectively. The region delineated by the seventh front intersecting point P₇, the seventh rear intersecting point Q₇, the eighth rear intersecting point Q₈ and the eighth front intersecting point P₈ is a combined view volume V₁ according to the second embodiment. As mentioned earlier, the space delineated by the first front intersecting point P₁, the first rear intersecting point Q₁, the second rear intersecting point Q₂ and the second front intersecting point P₂ corresponds to a finally used region.

Since the viewing angle of the temporary camera 22 is increased, it is necessary for a two-dimensional image generator 140 to acquire the two-dimensional images by increasing the number of pixels in the horizontal direction. When the number of pixels in the horizontal direction of two-dimensional images generated for a combined view volume V₁ is denoted by L′, the following relation holds between L′ and L, which is the number of pixels in the horizontal direction of two-dimensional images generated for a finally used region:
L′:L=Stan(θ′/2):Stan(θ/2)
As a result, L′ is given by
L′=L tan(θ′/2)/tan(θ/2)

The two-dimensional image generator 140 acquires two-dimensional images by increasing the number of pixels in the horizontal direction to L tan(θ′/2)/tan(θ/2) at the time of projection. If θ is sufficiently small, the two-dimensional images may be acquired by approximating L tan(θ′/2)/tan(θ/2) as L′/θ. Also, the two-dimensional images may be acquired by increasing the number of pixels L in the horizontal direction to the larger of L+M and L+N.

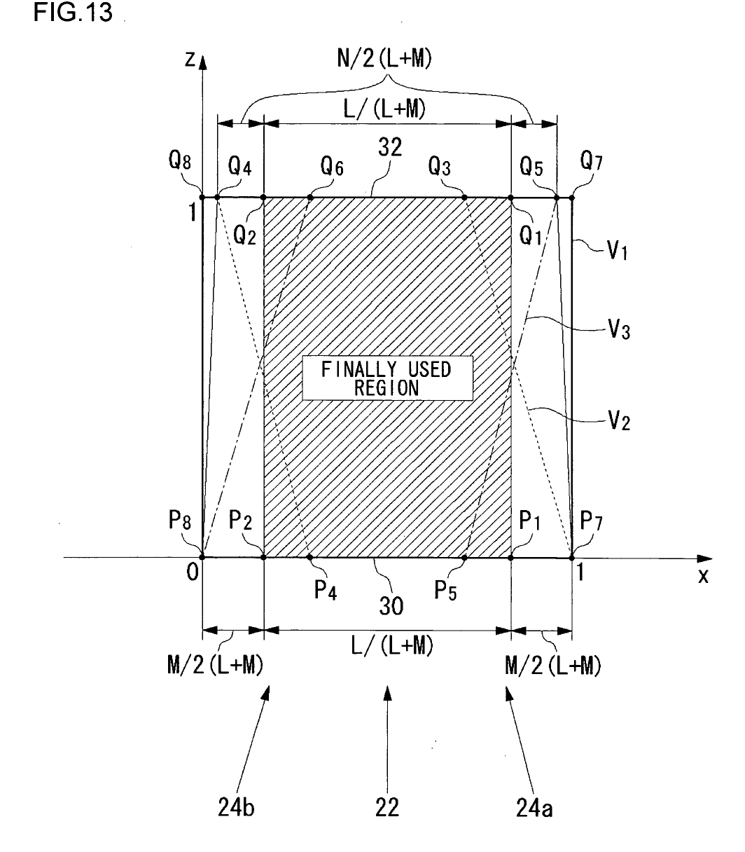

FIG. 13 illustrates a relationship among a combined view volume V₁, a right-eye view volume V₂ and a left-eye view volume V₃ after normalizing transformation. The vertical axis is the Z axis, and the horizontal axis is the X axis. As shown in FIG. 13, the combined view volume V₁ of a temporary camera 22 is transformed into a normalized coordinate system by a normalizing transformation unit 137. The region delineated by the seventh front intersecting point P₇, the seventh rear intersecting point Q₇, an eighth rear intersecting point Q₈ and the eighth front intersecting point P₈ corresponds to the combined view volume V₁. The region delineated by the fourth front intersecting point P₄, the seventh front intersecting point P₇, the third rear intersecting point Q₃ and the fourth rear intersecting point Q₄ corresponds to the right-eye view volume V₂ defined by the real right-eye camera 24a. The region delineated by the eighth front intersecting point P₈, the fifth front intersecting point P₅, the fifth rear intersecting point Q₅ and the sixth rear intersecting point Q₆ corresponds to the left-eye view volume V₃ defined by the real left-eye camera 24b. The region delineated by the first front intersecting point P₁, the first rear intersecting point Q₁, the second rear intersecting point Q₂ and the second front intersecting point P₂ is the finally used region, and the data on the objects in this region is converted finally into data on two-dimensional images.

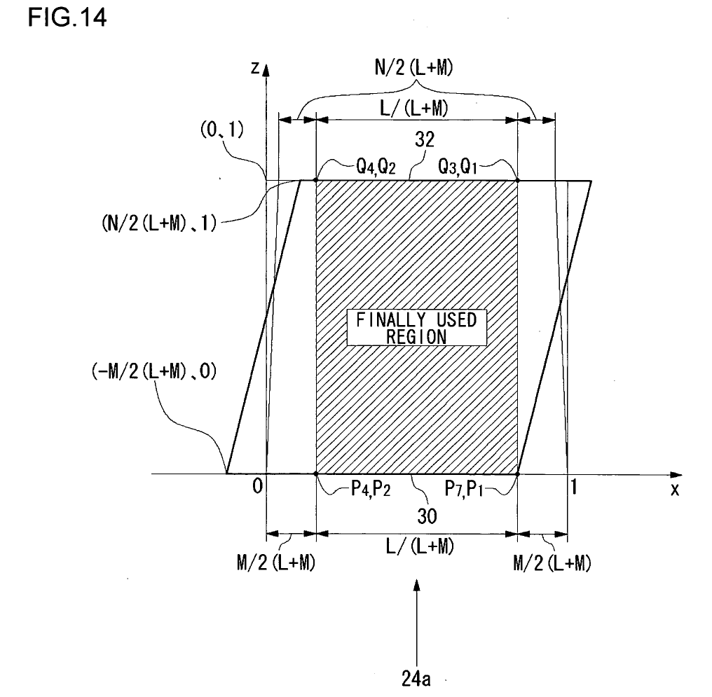

FIG. 14 illustrates a right-eye view volume V₂ after a skew transform processing. As shown in FIG. 14, as a result of the skew transform processing using the above-described skewing transformation matrix, the fourth front intersecting point P₄ coincides with the second front intersecting point P₂, the seventh front intersecting point P₇ with the first front intersecting point P₁, the third rear intersecting point Q₃ with the first rear intersecting point Q₁, and the fourth rear intersecting point Q₄ with the second rear intersecting point Q₂, and consequently the right-eye view volume V₂ coincides with the finally used region. A skew transform processing similar to the one for the right-eye view volume V₂ is also carried out for the left-eye view volume V₃.

In this manner, two two-dimensional images, which serve as base points for a parallax image, can be generated by a temporary camera only by acquiring view volumes for the respective real cameras through the skewing transformation performed on the combined view volume. As a result, the process for actually placing real cameras in a virtual three-dimensional space can be eliminated, thus realizing a high-speed three-dimensional image processing as a whole. This provides a great advantage particularly when there are a large number of real cameras to be placed, and enjoys the same advantageous effects as in the first embodiment.

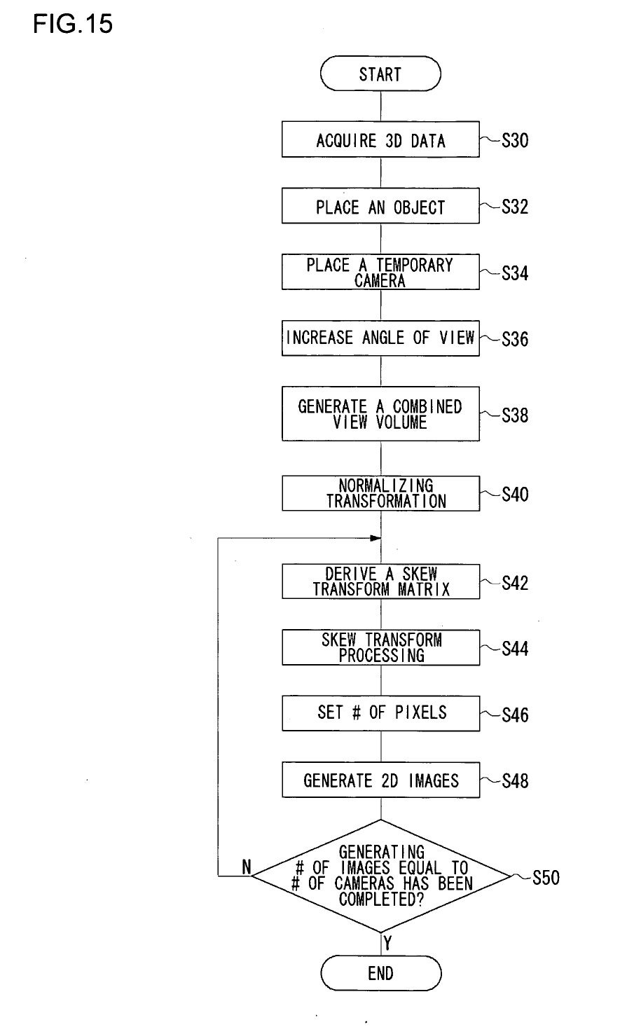

FIG. 15 is a flowchart showing the processing to generate a parallax image. This processing is repeated for each frame. The three-dimensional image processing apparatus 100 acquires three-dimensional data (S30). The object defining unit 132 places objects in a virtual three-dimensional space based on the three-dimensional data acquired by the three-dimensional image processing apparatus 100 (S32). The temporary camera placing unit 134 places a temporary camera within the virtual three-dimensional space (S34). After the placement of the temporary camera by the temporary camera placing unit 134, the view volume generator 136 derives a first horizontal displacement amount d₁ and a second horizontal displacement amount d₂ and increases the viewing angle θ of the temporary camera 22 to θ′ (S36). The view volume generator 136 generates a combined view volume V₁ based on the increased viewing angle θ′ of the temporary camera 22 (S38).

The normalizing transformation unit 137 transforms the combined view volume V₁ into a normalized coordinate system (S40). The skew transform processing unit 138 derives a skewing transformation matrix (S42) and performs a skew transform processing on the combined view volume V₁ based on the thus derived skewing transformation matrix and thereby acquires view volumes to be determined by real cameras 24 (S44). The two-dimensional image generator 140 sets the number of pixels in the horizontal direction for the two-dimensional images to be generated at the time of projection (S46). The two-dimensional image generator 140 generates once the two-dimensional images for the set number of pixels by projecting the respective view volumes for the real cameras on the screen surface and generates, from among the set number of pixels, the images for the number of pixels L as a plurality of two-dimensional images, namely, parallax images (S48). When the number of two-dimensional images equal to the number of the real cameras 24 has not been generated (N of S50), the processing from the derivation of a skewing transformation matrix on is repeated. When the number of two-dimensional images equal to the number of the real cameras 24 has been generated (Y of S50), the processing for a frame is completed.

### THIRD EMBODIMENT

In the first and second embodiments, the positions of a front clipping plane and a back clipping plane are determined by the z-buffer method. According to a third embodiment of the present invention, a front projection plane and a back projection plane are set as a front clipping plane and a back clipping plane, respectively. This processing can be accomplished by a structure similar to a three-dimensional image processing apparatus 100 according to the second embodiment. However, the view volume generator 136 has a function of generating a combined view volume by the use of a front projection plane and a back projection plane, instead of generating a combined view volume by the use of a frontmost object plane and a rearmost object plane. Here, the positions of the front projection plane and the back projection plane are determined by the user or the like in such a manner that objects to be three-dimensional displayed are adequately included. This arrangement of including the front projection plane and the back projection plane within the range of a finally used region enables a three-dimensional display of objects included in the finally used region with high certainty.

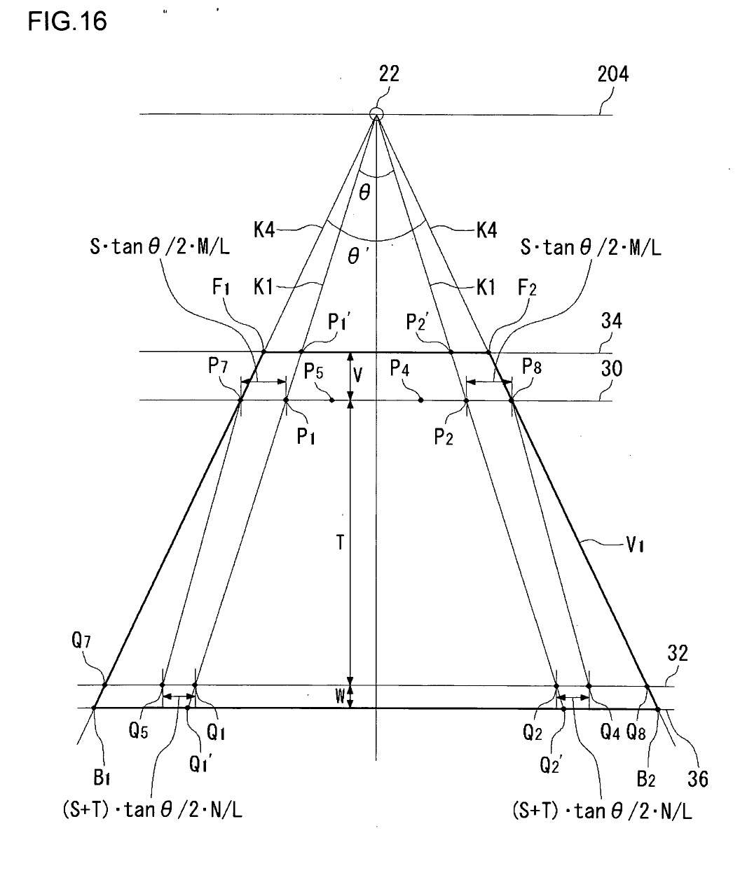

FIG. 16 illustrates how a combined view volume is generated by using a front projection plane 34 and a back projection plane 36. The same reference numbers are used for the same parts as in FIG. 6 or FIG. 12 and their repeated explanation will be omitted as appropriate. The positions where the fourth lines of sight K4, led from a temporary camera 22 placed on a viewpoint plane 204, intersect with a front projection plane 34 are denoted by a first front projection intersecting point F₁ and a second front projection intersecting point F₂, respectively, and the positions where the fourth lines of sight K4 intersect with a back projection plane 36 are denoted by a first back projection intersecting point B₁ and a second back projection intersecting point B₂, respectively. The positions where the fourth lines of sight K4 intersect with the front projection plane 34 are denoted by a first front intersecting point P₁′ and a second front intersecting point P₂′, respectively, and the positions where the fourth lines of sight K4 intersect with the back projection plane 36 are denoted by a first rear intersecting point Q₁ ′ and a second rear intersecting point Q₂′, respectively. The interval in the Z-axis direction between the front projection plane 34 and the frontmost object plane 30 is denoted by V₁ and the interval in the Z-axis direction between the rearmost object plane 32 and the back projection plane 36 is denoted by W. The region delineated by the first front projection intersecting point F₁, the first back projection intersecting point B₁, the second back projection intersecting point B₂ and the second front projection intersecting point F₂ is a combined view volume V₁ according to the third embodiment.

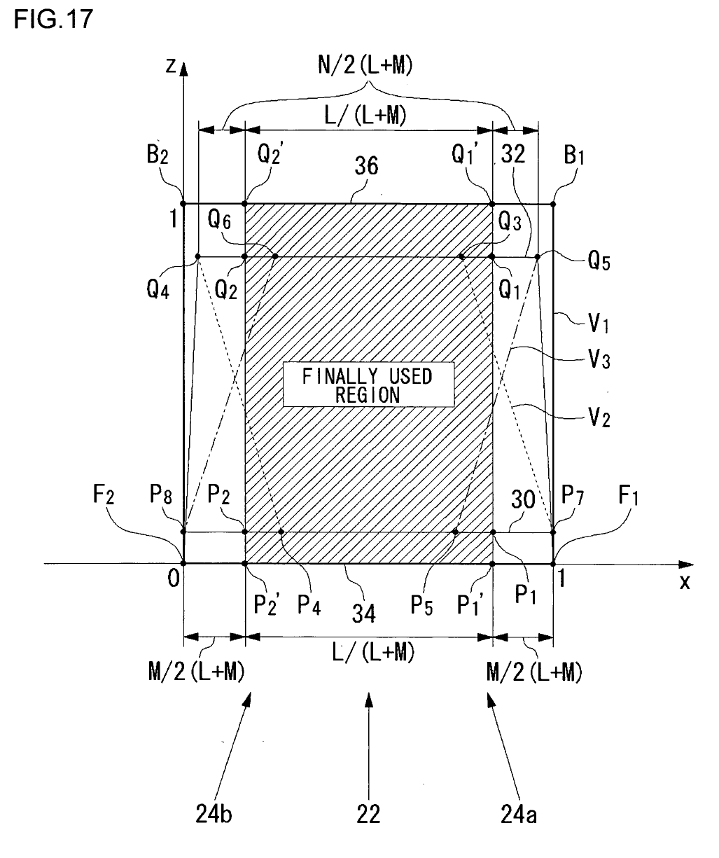

FIG. 17 illustrates a relationship among a combined view volume V₁, a right-eye view volume V₂ and a left-eye view volume V₃ after normalizing transformation. The vertical axis is the Z axis, and the horizontal axis is the X axis. As shown in FIG. 17, the combined view volume V₁ of a temporary camera 22 is transformed into a normalized coordinate system by a normalizing transformation unit 137. The region delineated by a fourth front intersecting point P₄, a seventh front intersecting point P₇, a third rear intersecting point Q₃ and a fourth rear intersecting point Q₄ corresponds to the right-eye view volume V₂ defined by the real right-eye camera 24a. The region delineated by an eighth front intersecting point P₈, a fifth front intersecting point P₅, a fifth rear intersecting point Q₅ and a sixth rear intersecting point Q₆ corresponds to the left-eye view volume V₃ defined by the real left-eye camera 24b. The region delineated by the second front intersecting point P₂′, the first front intersecting point P₁′, the first rear intersecting point Q₁′ and the second rear intersecting point Q₂′ is the finally used region, and the data on the objects in this region is converted finally into data on two-dimensional images.

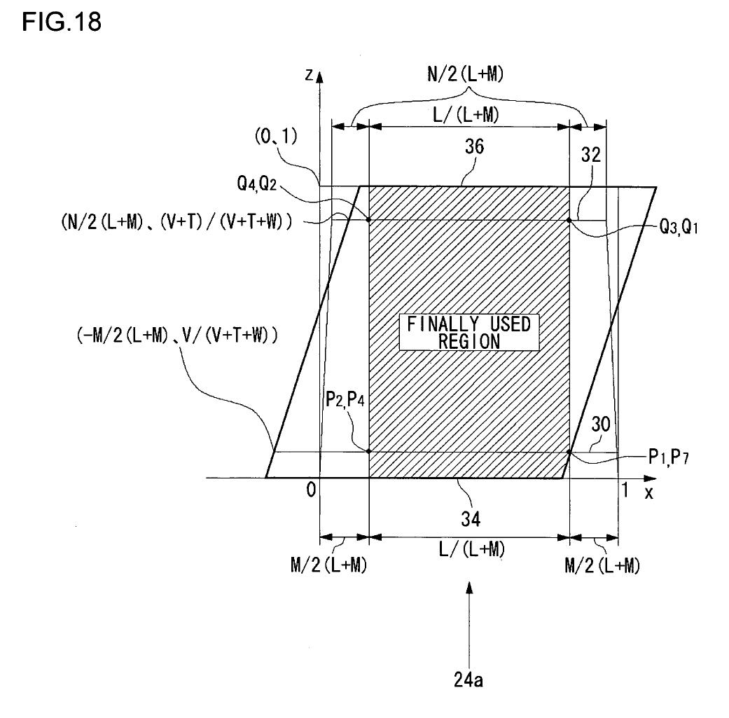

FIG. 18 illustrates a right-eye view volume V₂ after a skew transform processing. As shown in FIG. 18, as a result of the skew transform processing using the above-described skewing transformation matrix, the fourth front intersecting point P₄ coincides with a second front intersecting point P₂, the seventh front intersecting point P₇ with a first front intersecting point P₁, the third rear intersecting point Q₃ with a first rear intersecting point Q₁, and the fourth rear intersecting point Q₄ with a second rear intersecting point Q₂. A skew transform processing similar to the one for the right-eye view volume V₂ is also carried out for the left-eye view volume V₃.

In this manner, two two-dimensional images, which serve as base points for a parallax image, can be generated by a temporary camera only by acquiring view volumes for the respective real cameras through the skewing transformation performed on the combined view volume. As a result, the process for actually placing real cameras in a virtual three-dimensional space can be eliminated, thus realizing a high-speed three-dimensional image processing as a whole. This provides a great advantage particularly when there are a large number of real cameras to be placed, and enjoys the same advantageous effects as in the first embodiment.

### FOURTH EMBODIMENT

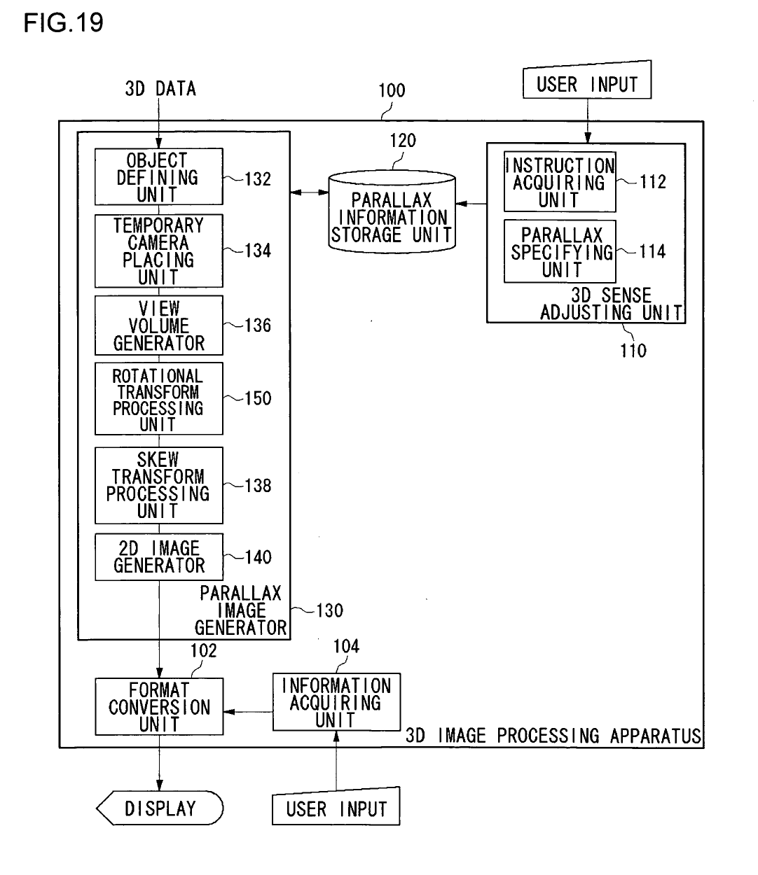

A fourth embodiment of the present invention differs from the first embodiment in that a rotational transformation, instead of a skewing transformation, is done to the combined view volume. FIG. 19 illustrates a structure of a three-dimensional image processing apparatus 100 according to the fourth embodiment. In the following description, the same reference numbers are used for the same components as in the first embodiment and their repeated explanation will be omitted as appropriate. The three-dimensional image processing apparatus 100 according to the fourth embodiment is provided with a rotational transform processing unit 150 in the place of a skew transform processing unit 138 of the three-dimensional image processing apparatus 100 shown in FIG. 1. The flow of processing in accordance with the above structure is the same as the one in the first embodiment.

In the same way as with the skew transform processing unit 138, the rotational transform processing unit 150 derives a rotational transformation matrix to be described later and applies the rotational transformation matrix to a normalizing-transformed combined view volume V₁ and thereby acquires view volumes to be determined by the respective real cameras 24.

Here, the rotational transformation matrix is derived as described below. FIG. 20 illustrates a relationship among a combined view volume after normalizing transformation, a right-eye view volume and a left-eye view volume. Although the rotation center in this fourth embodiment is the coordinates (0.5, Y, M/(M+N)), the coordinates (Cₓ, C_{y}, C_{z}) are used therefor for the convenience of explanation. Firstly the rotational transform processing unit 150 parallel-translates the rotation center to the origin. At this time, the coordinates (X₀, Y₀, Z₀) in the combined view volume V₁ are parallel-translated to the coordinates (X₁, Y₁, Z₁), and therefore the transformation formula is expressed as

$$( \begin{matrix}{X}_{1} \\ {Y}_{1} \\ {Z}_{1} \\ 1\end{matrix} ) = ( \begin{matrix}1 & 0 & 0 & - {C}_{x} \\ 0 & 1 & 0 & 0 \\ 0 & 0 & 1 & - {C}_{z} \\ 0 & 0 & 0 & 1\end{matrix} ) ( \begin{matrix}{X}_{0} \\ {Y}_{0} \\ {Z}_{0} \\ 1\end{matrix} ) \qquad ( Equation 2 )$$

Next, with the Y axis as the axis of rotation, the coordinates (X₁, Y₁, Z₁) are rotated by the angle φ to the coordinates (X₂, Y₂, Z₂) The angle φ is the angle defined by a line segment joining the fourth front intersecting point P₄ and the fourth rear intersecting point Q₄ and a line segment joining the second front intersecting point P₂ and the second rear intersecting point Q₂ in FIG. 9. For the angle θ, the clockwise rotation is defined to be positive in relation to the positive direction of the Y axis. The transformation is expressed as

$$( \begin{matrix}{X}_{2} \\ {Y}_{2} \\ {Z}_{2} \\ 1\end{matrix} ) = ( \begin{matrix}cos ϕ & 0 & - sin ϕ & 0 \\ 0 & 1 & 0 & 0 \\ sin ϕ & 0 & cos ϕ & 0 \\ 0 & 0 & 0 & 1\end{matrix} ) ( \begin{matrix}{X}_{1} \\ {Y}_{1} \\ {Z}_{1} \\ 1\end{matrix} ) \qquad ( Equation 3 )$$

Finally, the rotation center at the origin is parallel-translated back to the coordinates (Cₓ, C_{y}, C_{z}) as follows.

$$( \begin{matrix}{X}_{3} \\ {Y}_{3} \\ {Z}_{3} \\ 1\end{matrix} ) = ( \begin{matrix}1 & 0 & 0 & {C}_{x} \\ 0 & 1 & 0 & 0 \\ 0 & 0 & 1 & {C}_{z} \\ 0 & 0 & 0 & 1\end{matrix} ) ( \begin{matrix}{X}_{2} \\ {Y}_{2} \\ {Z}_{2} \\ 1\end{matrix} ) \qquad ( Equation 4 )$$

As a result of such a rotational transform professing as above, two two-dimensional images, which serve as base points for a parallax image, can be generated by a temporary camera only by acquiring view volumes for the respective real cameras through the rotational transformation performed on the combined view volume. Thus, the process for actually placing real cameras in a virtual three-dimensional space can be eliminated, thus realizing a high-speed three-dimensional image processing as a whole. This provides a great advantage particularly when there are a large number of real cameras to be placed.

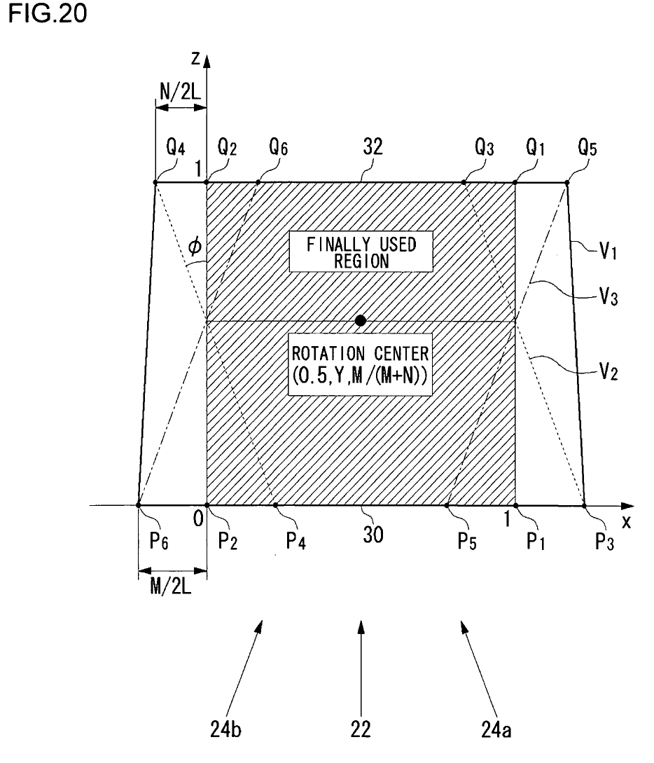

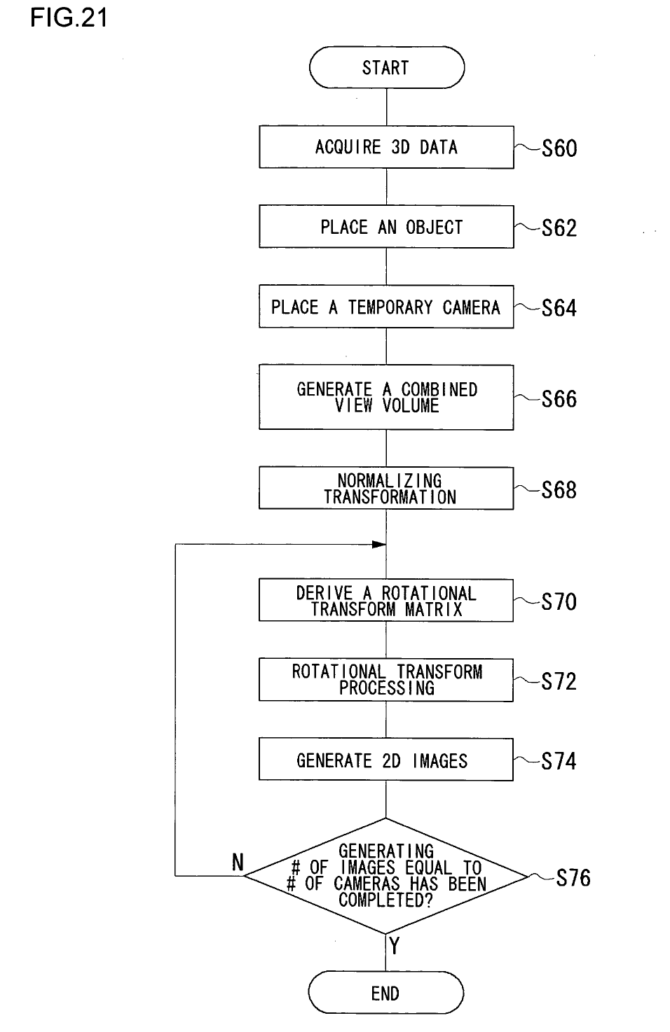

FIG. 21 is a flowchart showing the processing to generate parallax images. This processing is repeated for each frame. The three-dimensional image processing apparatus 100 acquires three-dimensional data (S60). The object defining unit 132 places objects in a virtual three-dimensional space based on the three-dimensional data acquired by the three-dimensional image processing apparatus 100 (S62). The temporary camera placing unit 134 places a temporary camera within the virtual three-dimensional space (S64). After the placement of the temporary camera by the temporary camera placing unit 134, the view volume generator 136 generates a combined view volume V₁ by deriving a first horizontal displacement amount d₁ and a second horizontal displacement amount d₂ (S66).

The normalizing transformation unit 137 transforms the combined view volume V₁ into a normalized coordinate system (S68). The rotational transform processing unit 150 derives a rotational transformation matrix (S70) and performs a rotational transform processing on the combined view volume V₁ based on the rotational transformation matrix and thereby acquires view volumes to be determined by real cameras 24 (S72) The two-dimensional image generator 140 generates a plurality of two-dimensional images, namely, parallax images, by projecting the respective view volumes of the real cameras on the screen surface (S74). When the number of two-dimensional images equal to the number of the real cameras 24 has not been generated (N of S76), the processing from the derivation of a rotational transformation matrix on is repeated. When the number of two-dimensional images equal to the number of the real cameras 24 has been generated (Y of S76), the processing for a frame is completed.

### FIFTH EMBODIMENT

A fifth embodiment of the present invention differs from the second embodiment in that a rotational transformation, instead of a skewing transformation, is done to the combined view volume. A three-dimensional image processing apparatus 100 according to the fifth embodiment is provided anew with an aforementioned rotational transform processing unit 150 in place of the skew transform processing unit 138 of the three-dimensional image processing apparatus 100 according to the second embodiment. The rotation center in this fifth embodiment is the coordinates (0.5, Y, M/(M+N)). The flow of processing in accordance with the above structure is the same as the one in the second embodiment. Thus the same advantageous effects as in the second embodiment can be achieved.

### SIXTH EMBODIMENT

A sixth embodiment of the present invention differs from the third embodiment in that a rotational transformation, instead of a skewing transformation, is performed on the combined view volume. A three-dimensional image processing apparatus 100 according to the sixth embodiment is provided anew with an aforementioned rotational transform processing unit 150 in place of the skew transform processing unit 148 of the three-dimensional image processing apparatus 100 according to the third embodiment. The rotation center in this sixth embodiment is the coordinates (0.5, Y, {V+TM/(M+N)}/(V+T+W)). The flow of processing in accordance with the above structure is the same as the one in the third embodiment. Thus the same advantageous effects as in the third embodiment can be achieved.

### SEVENTH EMBODIMENT

A seventh embodiment differs from the above embodiments in that the transformation of the combined view volume V₁ by the normalizing transformation unit 137 into a normalized coordinate system is of nonlinear nature. Although the structure of a three-dimensional image processing apparatus 100 according to the seventh embodiment is the same as that according to the first embodiment, the normalizing transformation unit 137 further has the following functions.

The normalizing transformation unit 137 both transforms the combined view volume V₁ into a normalized coordinate system, and performs a compression processing in a depth direction on an object positioned by an object defining unit 132, according to a distance in the depth direction from a temporary camera placed by a temporary viewpoint placing unit 134. Specifically, for example, the normalizing transformation unit 137 performs the compression processing in a manner such that the larger the distance in the depth direction from the temporary camera, the higher a compression ratio in the depth direction.

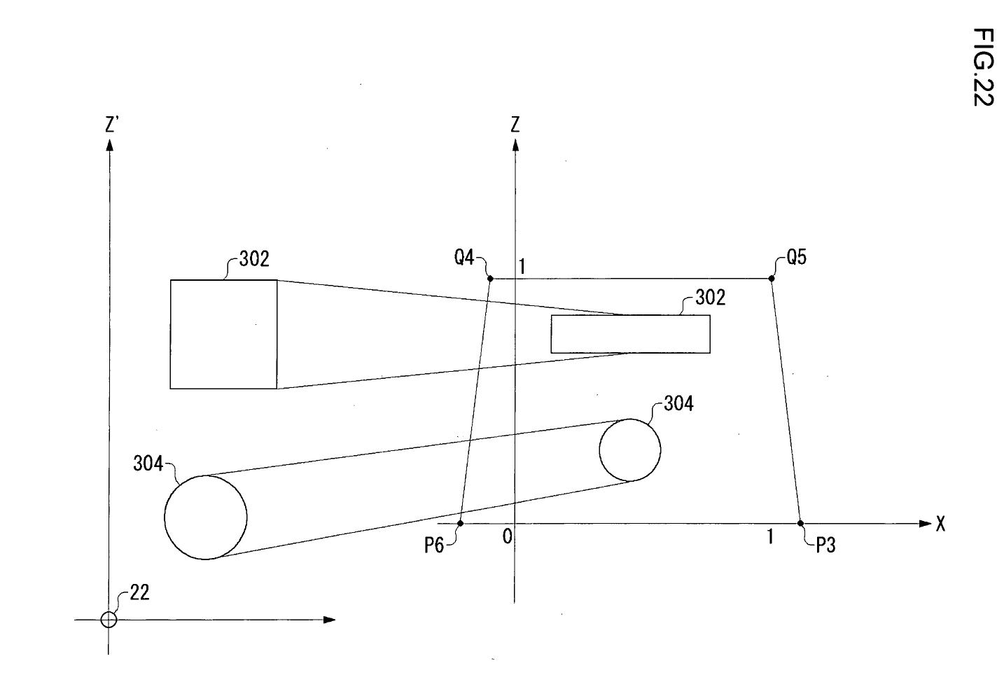

FIG. 22 schematically illustrates a compression processing in the depth direction by the normalizing transformation unit 137. The coordinate system shown in the left-hand side of FIG. 22 is a camera coordinate system with a temporary camera being positioned at the origin, and the Z′-axis direction is the depth direction. The Z′-axis direction is the same as the positive direction along which the z-value increases. As shown in FIG. 22, a second object 304 is placed in a position closer to the temporary camera 22 than a first object 302 is.

The coordinate system shown in the right-hand side of FIG. 22, on the other hand, is a normalized coordinate system. As described earlier, a region surrounded by the third front intersecting point P₃, the fifth rear intersecting point Q₅, the fourth rear intersecting point Q₄ and the sixth front intersecting point P₆ is a combined view volume V₁ which is transformed by the normalizing transformation unit 137 into the normalized coordinate system.

Referring still to FIG. 22, the first object 302 is placed farther from he temporary camera 22, a compression processing in which the compression ratio is high in the depth direction is carried out, so that the length of the first object 302 in the depth direction in the normalized coordinate system shown in the right-hand side of FIG. 22 becomes extremely short.

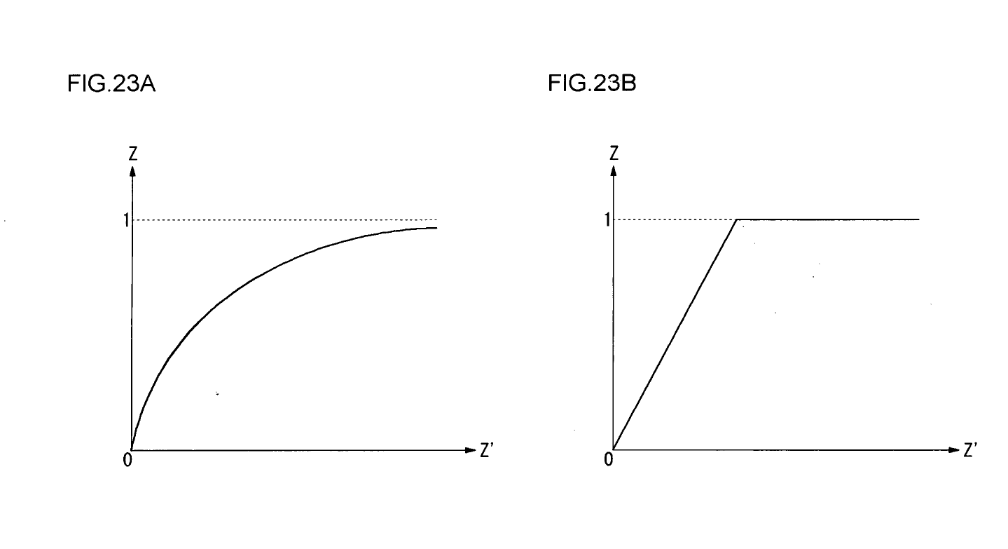

FIG. 23A illustrates a first relationship between values in the Z′-axis direction and those in the Z-axis direction in a compression processing. FIG. 23B illustrates a second relationship between values in the Z′-axis direction and those in the Z-axis direction in a compression processing. The compression processing in the depth direction by the normalizing transformation unit 137 according to the seventh embodiment is carried out based on this first or second relationship. Under the first relationship the normalizing transformation unit 137 performs compression processing on an object in such a manner that the larger the value in the Z′-axis direction, the smaller the increased amount of the value in the Z-axis direction against the increased amount thereof in the Z-axis direction. Under the second relationship the normalizing transformation unit 137 performs compression processing on an object in such a manner that when the value in the Z′-axis direction exceeds a certain fixed value, the change of value in the Z-axis direction relative to the increase of value in the Z′-axis direction is set to zero. In either case, the object placed far from the temporary viewpoint is subjected to the compression processing in which the compression ratio is high in the depth direction.

In fact, the range in which the binocular parallax is actually effective is said to be within approximately 20 meters or so. Thus it is oftentimes felt rather natural if the stereoscopic effect for an object placed far is set low. As a result thereof, the compression processing according to the seventh embodiment is meaningful and, above all, very useful.

### EIGHTH EMBODIMENT

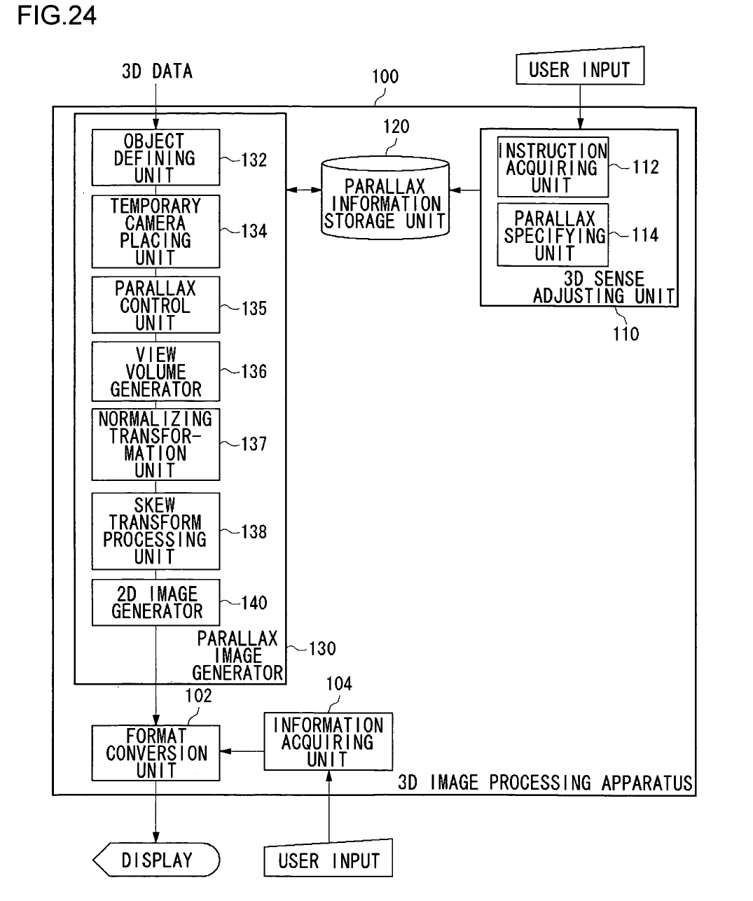

An eighth embodiment of the present invention differs from the first embodiment in that the nearer-positioned maximum parallax amount M and the farther-positioned maximum parallax amount N are corrected for appropriateness. FIG. 24 illustrates a structure of a three-dimensional image processing apparatus 100 according to the eighth embodiment of the present invention. The three-dimensional image processing apparatus 100 according to the eighth embodiment is such that a parallax control unit 135 is additionally provided to the three-dimensional image processing apparatus 100 according to the first embodiment. The same reference numbers are used for the same components as those of the first embodiment and their repeated explanation will be omitted as appropriate.

The parallax control unit 135 controls the nearer-positioned maximum parallax amount or the farther-positioned maximum parallax amount so that a parallax formed by a ratio of the width to the depth of an object expressed within a three-dimensional image at the time of generating the three-dimensional image does not exceed a parallax range properly perceived by human eyes. In this case, the parallax control unit 135 may include therein a camera placement correcting unit (not shown) which corrects camera parameters according to the appropriate parallax. The “three-dimensional images” are images displayed with the stereoscopic effect, and their entities of data are “parallax images” in which parallax is given to a plurality of images. The parallax images are generally a set of a plurality of two-dimensional images. This processing for controlling the nearer-positioned maximum parallax amount or the farther-positioned maximum parallax amount is carried out after the temporary camera has been placed in the virtual three-dimensional space by the temporary camera placing unit 134

Generally, for example, the processing may be such that the parallax of a three-dimensional image is made smaller when an appropriate parallax processing judges that the parallax is in a state of being too large for a correct parallax condition where a sphere can be seen correctly. At this time, the sphere is seen in a form crushed in the depth direction, but a sense of discomfort for this kind of display is generally small. People, who are normally familiar with plane images, tend not to have a sense of discomfort, most of the time, as long as the parallax is between 0 and a correct parallax state.

Conversely, the processing may be such that the parallax is made larger when an appropriate parallax processing judges that the parallax of a three-dimensional image is too small for a parallax condition where a sphere can be seen correctly. At this time, the sphere is, for instance, seen in a form swelling in the depth direction, and people may have a sense of significant discomfort for this kind of display.

A phenomenon that gives a sense of discomfort to people as described above is more likely to occur, for example, when 3D displaying a stand-alone object. Particularly when objects often seen in real life, such as a building or a vehicle, are to be displayed, a sense of discomfort with visual appearance due to differences in parallax tends to be more clearly recognized. To reduce the sense of discomfort, a processing that increases the parallax needs correction.

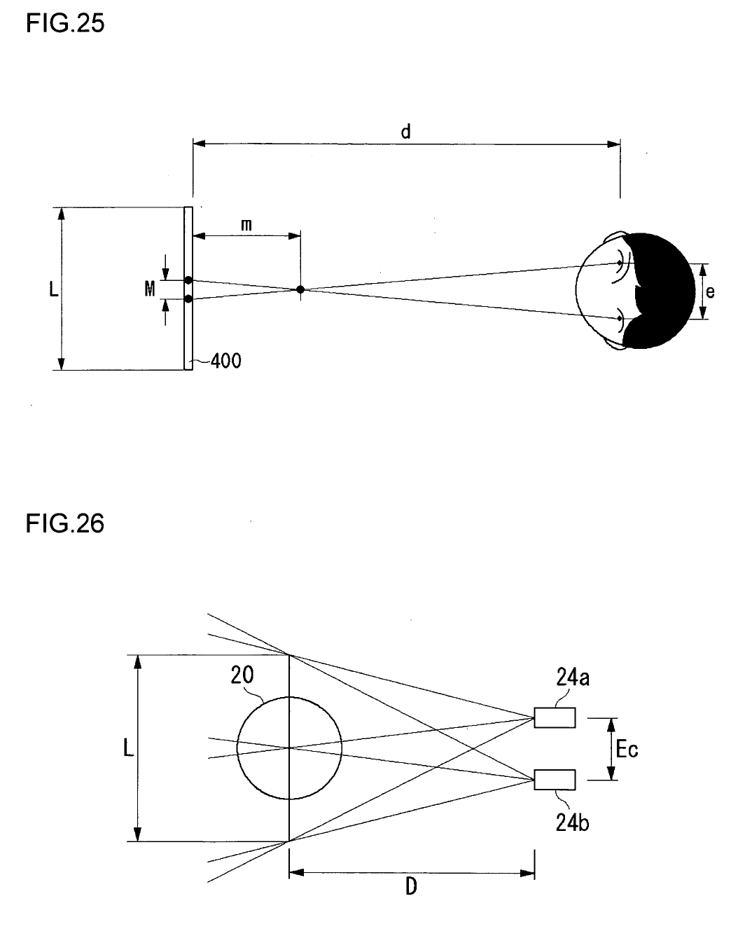

When three-dimensional images are to be created, the parallax can be adjusted with relative ease by changing the arrangement of the real cameras. In this patent specifications, as described earlier, the real cameras will not be actually placed within the virtual three-dimensional space at the time of creating the three dimensional images. Thus, it is assumed hereinafter that an imaginary real camera is placed and the parallax, for example, the nearer-positioned maximum parallax amount M and the farther-positioned maximum parallax amount N are corrected. With reference to FIGS. 25 through 30, parallax correction procedures will be shown.

FIG. 25 shows a state in which a viewer is viewing a three-dimensional image on a display screen 400 of a three-dimensional image display apparatus 100. The screen size of the display screen 400 is L, the distance between the display screen 400 and the viewer is d, and the distance between eyes is e. The nearer-positioned maximum parallax amount M and the farther-positioned maximum parallax amount N have already been obtained beforehand by a three-dimensional sense adjusting unit 110, and appropriate parallaxes are between the nearer-positioned maximum parallax amount M and the farther-positioned maximum parallax amount N. Here, for easier understanding, the nearer-positioned maximum parallax amount M only is displayed, and the maximum fly-out amount m is determined from this value. The fly-out amount m is the distance from the display screen 400 to the nearer-position point. It is to be noted that L, M and N are given in units of “pixels”, and unlike such other parameters as d, m and e, they need primarily be adjusted using predetermined conversion formulas. Here, however, they are represented in the same unit system for easier explanation. In the present embodiment, it is assumed that the number of pixels of a two-dimensional image in the horizontal direction and the size of screen are both equal to L.

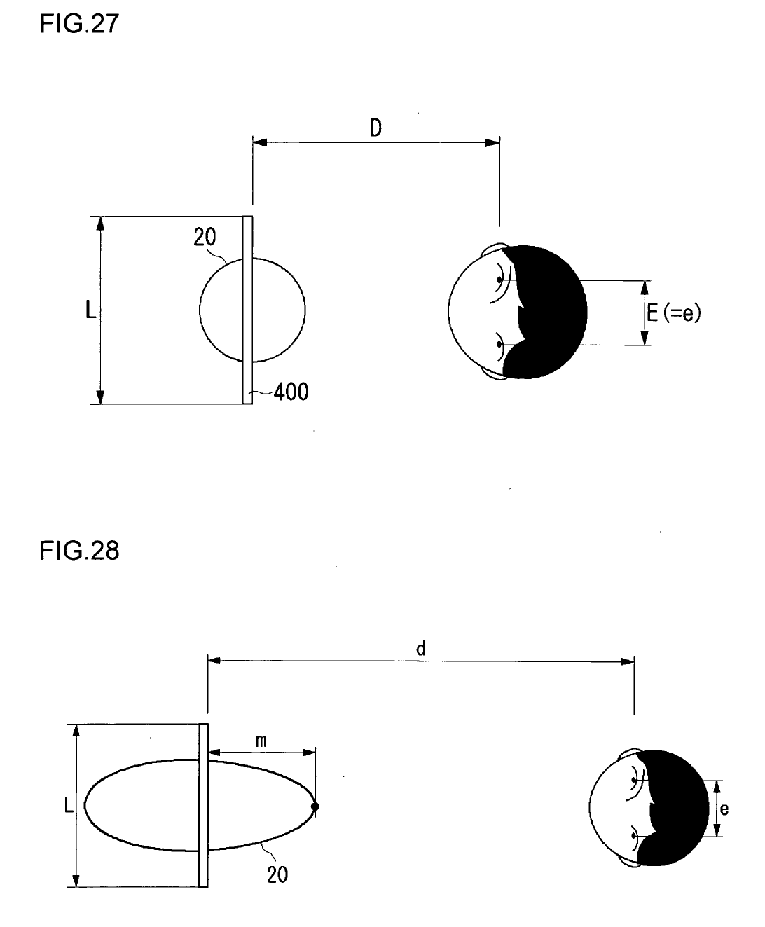

At this time, assume that in order to display a sphere object 20 the arrangement of real cameras is determined as shown in FIG. 26 at the time of initial setting, with reference to the nearest-position point and the farthest-position point of the object 20. The optical axis intersection distance of a right-eye camera 24a and a left-eye camera 24b is D, and the interval between the cameras is Ec. However, to make the comparison of parameters easier, an enlargement/reduction processing of the coordinate system is done in a manner such that the subtended width of the cameras at the optical axis intersection distance coincides with the screen size L. At this time, suppose, for instance, that the interval between cameras Ec is equal to the distance e between eyes and that the viewing distance d is equal to the optical axis intersection distance D in the three-dimensional image processing apparatus 100. Then, in this system, as shown in FIG. 27, the object 20 looks correctly when the viewer views it from the camera position shown in FIG. 26. On the other hand, suppose, for instance, that the interval between cameras Ec is equal to the distance e between eyes and that the viewing distance d is larger than the optical axis intersection distance D in the three-dimensional image processing apparatus 100. Then, when an object 20 in an image generated by a shooting system as shown in FIG. 26 is viewed through a display screen of the three-dimensional image processing apparatus 100, the object 20 which is elongated in the depth direction over the whole appropriate parallax range is observed as shown in FIG. 28.

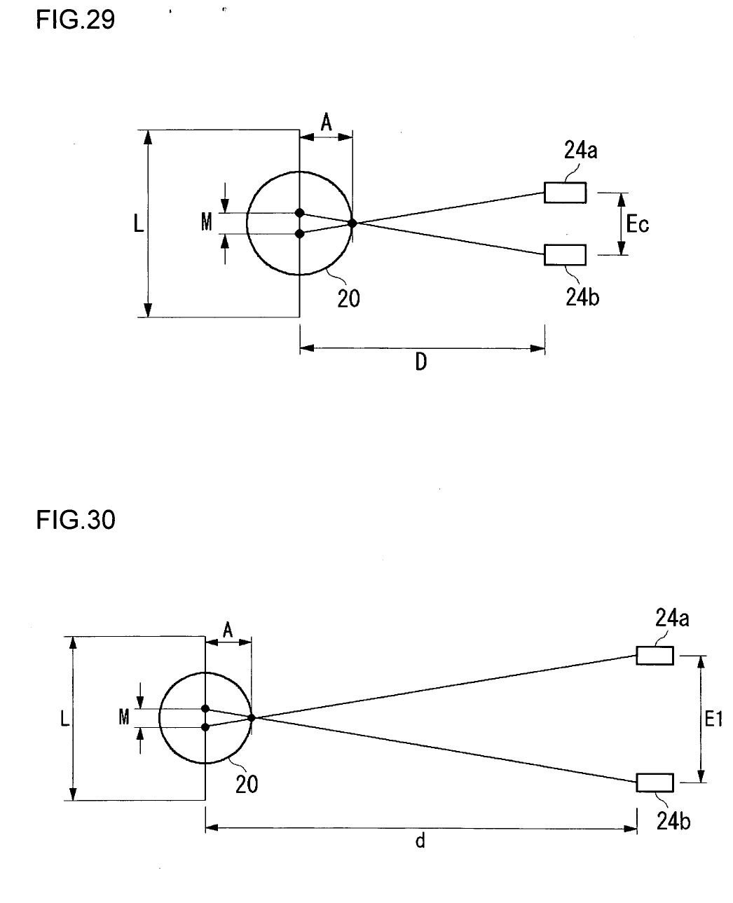

A technique for judging whether or not correction is necessary to a three-dimensional image using this principle will be described hereinbelow. FIG. 29 shows a state in which the nearest-position point of a sphere positioned at a distance of A from the display screen 400 is shot from a camera placement shown in FIG. 26. At this time, the maximum parallax M corresponding to distance A is determined by the two straight lines connecting each of the right-eye camera 24a and the left-eye camera 24b with the point positioned at distance A. FIG. 30 shows the camera interval El necessary for obtaining the parallax M shown in FIG. 29 when an optical axis tolerance distance of the cameras from theses two cameras is d. This can be said to be a conversion in which all the parameters of the shooting system other than the camera interval are brought into agreement with the parameters of the viewing system. In FIG. 29 and FIG. 30, the following relations hold:
M:A=Ec:D-A
M:A=E1:d-A
Ec=E1(D-A)/(d-A)
E1=Ec(d-A)/(D-A)

And it is judged that a correction to make the parallax smaller is necessary when E1 is larger than the distance e between eyes. Since it suffices that E1 is made to equal the distance e between eyes, it is preferable that Ec be corrected as shown in the following equation:
Ec=e(D-A)/(d-A)

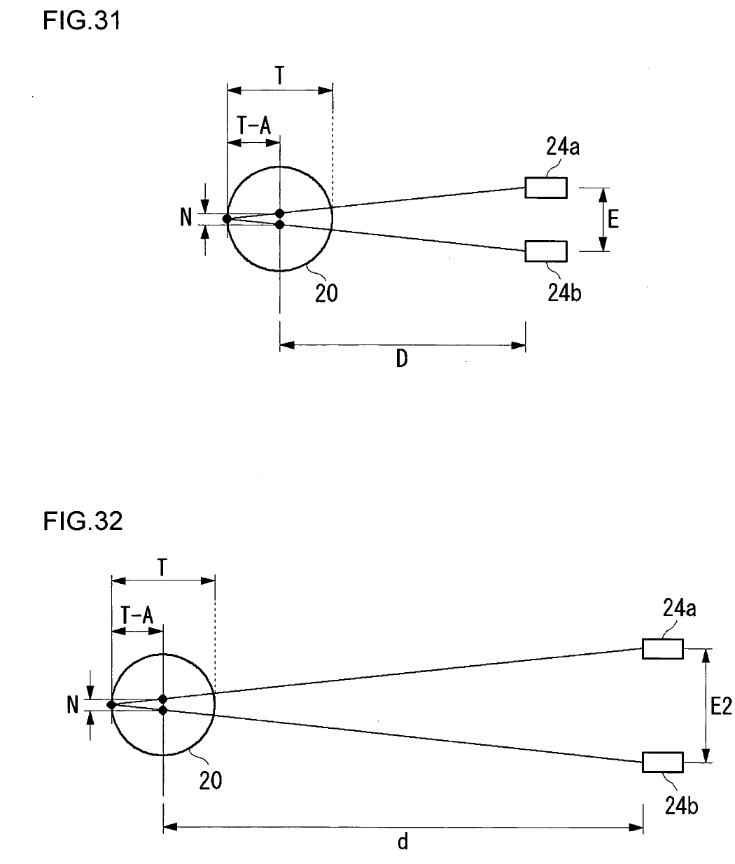

The same thing can be said of the farthest-position point. If the distance between the nearest-position point and the farthest-position point of an object 20 in FIG. 31 and FIG. 32 is T, which is the range of a finally used region, then
N:T-A=Ec:D+T-A
N:T-A=E2:d+T-A
Ec=E2(D+T-A)/(d+T-A)
E2=Ec(d+T-A)/(D+T-A)

Moreover, it is judged that a correction is necessary when E2 is larger than the distance e between eyes. Subsequently, since it suffices that E2 is made to equal the distance e between eyes, it is preferred that Ec be corrected as shown in the following equation:
Ec=e(D+T-A)/(d+T-A)

Finally, if the smaller of the two Ec's obtained from the nearest-position point and the farthest-position point, respectively, is selected, there will be no too large parallax for both the nearer-position and the farther-position. The cameras are set by returning this selected Ec to the coordinate system of the original three-dimensional space.

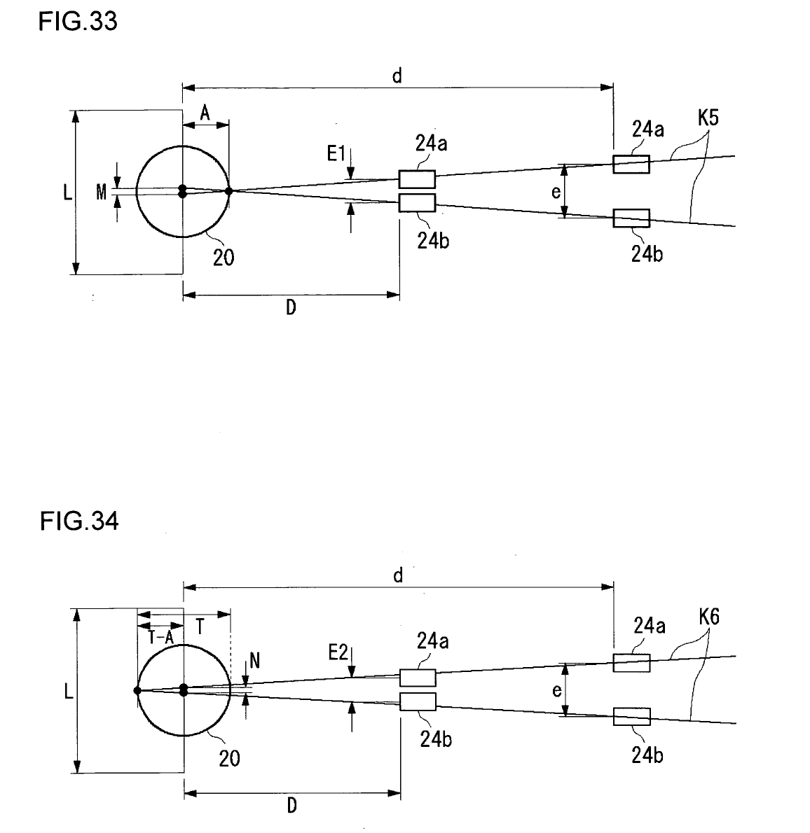

More generally, the camera interval Ec is preferably set in such a manner as to satisfy the following two equations simultaneously:
Ec<e(D-A)/(d-A)
Ec<e(D+T-A)/(d+T-A)
This indicates that in FIG. 33 and FIG. 34 the interval of two cameras placed on the two optical axes K5 connecting the right-eye camera 24a and the left-eye camera 24b, which are not actually placed at the time of generating two-dimensional images but placed at the position of viewing distance d at an interval of the distance e between eyes with the nearest-position point of an object or on the two optical axes K6 connecting the right-eye camera 24a and the left-eye camera 24b with the farthest-position point thereof is the upper limit of the camera interval Ec. In other words, it is preferred that the camera parameters be determined in such a manner that the two cameras are held between the optical axes of the narrower of the interval of the two optical axes K5 in FIG. 33 and the interval of the two optical axes K6 in FIG. 34.

When the camera interval Ec is corrected in this manner, the parallax control unit 135 derives the nearer-positioned maximum parallax amount M or the farther-positioned maximum parallax amount N for the thus corrected camera interval Ec. That is,
M=EcA/(D−A)
is set as the nearer-positioned maximum parallax amount M. Similarly,
N=Ec(T−A)/(D+T−A)
is set as the farther-positioned maximum parallax amount N. After the nearer-positioned maximum parallax amount M or the farther-positioned maximum parallax amount N has been corrected by the parallax control unit 135, the aforementioned processing for generating a combined view volume is carried out and, thereafter, the processing similar to the first embodiment will be carried out.

Although the correction is made here by the camera interval only without changing the optical axis intersection distance, the optical axis intersection distance may be changed and the position of the object may be changed, or both the camera interval and optical axis intersection distance may be changed. According to the eighth embodiment, the sense of discomfort felt by a viewer of 3D images can be significantly reduced.

### NINTH EMBODIMENT

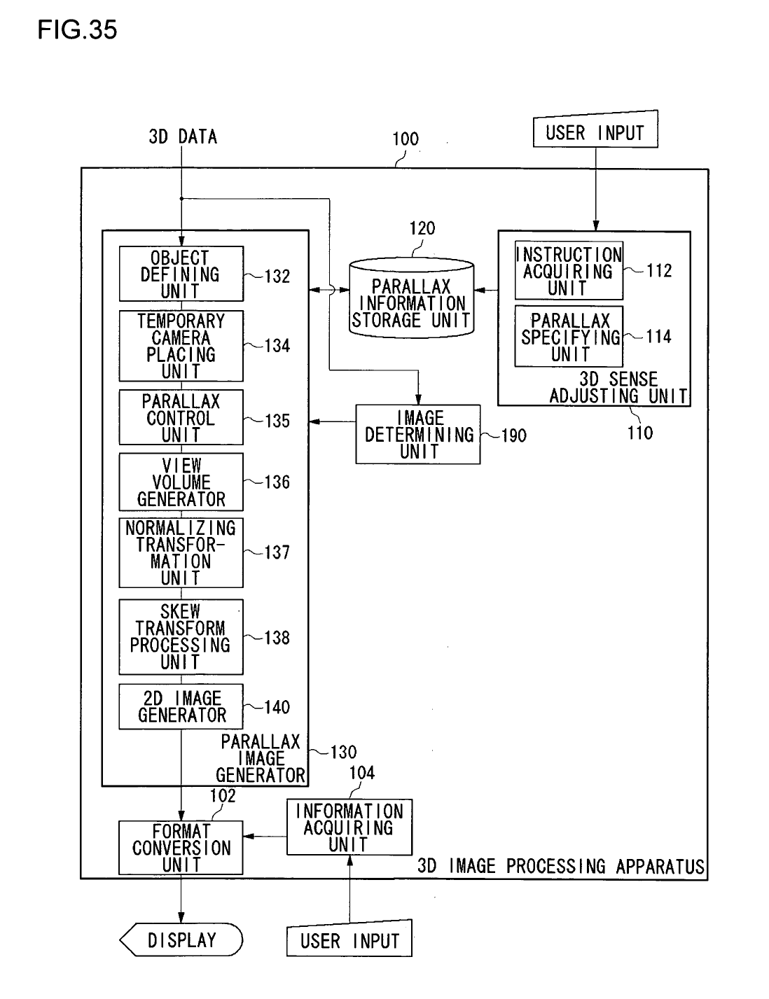

A ninth embodiment-of the present invention differs from the eighth embodiment in that the nearer-positioned maximum parallax amount M and the farther-positioned maximum parallax amount N obtained through a three-dimensional image processing apparatus 100 are corrected based on the frequency analysis or the movement status of an object. FIG. 35 illustrates a structure of a three-dimensional image processing apparatus 100 according to the ninth embodiment of the present invention. The three-dimensional image processing apparatus 100 according to the ninth embodiment is such that an image determining unit 190 is additionally provided to the three-dimensional image processing apparatus 100 according to the eighth embodiment. A parallax control unit 135 according to the ninth embodiment further has the following functions. The same reference numbers are used for the same components as those of the eighth embodiment and their repeated explanation will be omitted as appropriate.

The image determining unit 190 performs frequency analysis on a three-dimensional image to be displayed based on a plurality of two-dimensional images corresponding to different parallaxes. The parallax control unit 135 adjusts the nearer-positioned maximum parallax amount M or the farther-positioned maximum parallax amount N according to an amount of high frequency component determined by the frequency analysis. More specifically, if the amount of high frequency component is large, the parallax control unit 135 adjusts the nearer-positioned maximum parallax amount M or the farther-positioned maximum parallax amount N by making it larger. Here, the two dimensional-images are a plurality of images that constitute the parallax images, and may be called “viewpoint images” that have viewpoints corresponding thereto. That is, the parallax images are constituted by a plurality of two-dimensional images, and displaying them results as an three-dimensional image displayed.

Furthermore, the image determining unit 190 detects the movement of a three-dimensional image displayed based on a plurality of two-dimensional images corresponding to different parallaxes. In this case, the parallax control unit 135 adjusts the nearer-positioned maximum parallax amount M or the farther-positioned maximum parallax amount N according to the movement amount of a three-dimensional image. More specifically, if the movement amount of a three-dimensional image is large, the parallax control unit 135 adjusts the nearer-positioned maximum parallax amount M or the farther-positioned maximum parallax amount N by making it larger.

The limits of parallax that give a sense of discomfort to the viewers vary with images. Generally speaking, images with less changes in pattern or color and with conspicuous edges tend to cause more cross talk if the parallax given is large. Images with a large difference in brightness between both sides of the edges tend to cause a highly visible cross talk when parallax given is strong. That is, when there is less of high-frequency components in the images to be three-dimensionally displayed, namely, parallax images or viewpoint images, the user tends to have a sense of discomfort when he/she sees them. Therefore, it is preferable that images be subjected to a frequency analysis by such technique as Fourier transform, and correction be added to the appropriate parallaxes according to the distribution of frequency components obtained as a result the analysis. In other words, correction that makes the parallax larger than the appropriate parallax is added to the images which have more of high-frequency components.

Moreover, images with much movement have inconspicuous cross talk. Generally speaking, the type of a file is often identified as moving images or still images by checking the extension of a filename. When determined to be moving images, the state of motion may be detected by a known motion detection technique, such as motion vector method, and correction may be added to the appropriate parallax amount according to the status. To images with much motion or if the motion is to be emphasized, correction is added in such a manner that the parallax becomes larger than the primary parallax. On the other hand, to images with less motion, correction is added in such a manner that the parallax becomes smaller than the primary parallax. It is to be noted that the correction of appropriate parallaxes is only one example, and correction can be made in any case as long as the parallax is within a predetermined parallax range.

These analysis results may be recorded in the header area of a file, and a three-dimensional image processing apparatus may read the header and use it for the subsequent display of three-dimensional images. The amount of high-frequency components or the motion distribution may be ranked according to actual stereoscopic vision by a producer or user of images. The ranking by stereoscopic vision may be made by a plurality of evaluators and the average values may be used, and the technique used for the ranking does not matter here. After the nearer-positioned maximum parallax amount M or the farther-positioned maximum parallax amount N has been corrected by the parallax control unit 135, the aforementioned processing for generating a combined view volume is carried out and, thereafter, the processing similar to the first embodiment will be carried out.

Next, the structure according to the present embodiments will be described with reference to claim phraseology of the present invention by way of exemplary component arrangement. A “temporary viewpoint placing unit” corresponds to, but is not limited to, the temporary camera placing unit 134 whereas a “coordinate conversion unit” corresponds to, but is not limited to, the skew transform processing unit 138 and the rotational transform processing unit 150.

The present invention has been described based on the embodiments which are only exemplary. It is therefore understood by those skilled in the art that other various modifications to the combination of each component and process described above are possible and that such modifications are also within the scope of the present invention. Such modifications will be described hereinbelow.

In the present embodiments, the position of an optical axis intersecting plane 212 is uniquely determined with the nearer-positioned maximum parallax amount M and the farther-positioned maximum parallax amount N specified. As a modification, the user may determine a desired position of the optical axis intersecting plane 212. According to this modification, the user places a desired object on a screen surface and thus can operate the object so that it would not fly out. When the user decides on the position of an optical axis intersecting plane 212, it is possible that said position decided by the user differs from the position thereof determined uniquely by the nearer-positioned maximum parallax amount M and the farther-positioned maximum parallax amount N. For this reason, if the object is projected on such the optical axis intersecting plane 212, then the two-dimensional images with which to realize the nearer-positioned maximum parallax amount M and the farther-positioned maximum parallax amount N may not be generated. Hence, if the position of an optical axis intersecting plane 212 is fixed to a desired position, the view volume generator 136 gives priority to either the nearer-positioned maximum parallax amount M or the farther-positioned maximum parallax amount N and then generates the combined view volume based on the maximum parallax amount to which priority was given, as will be described later.

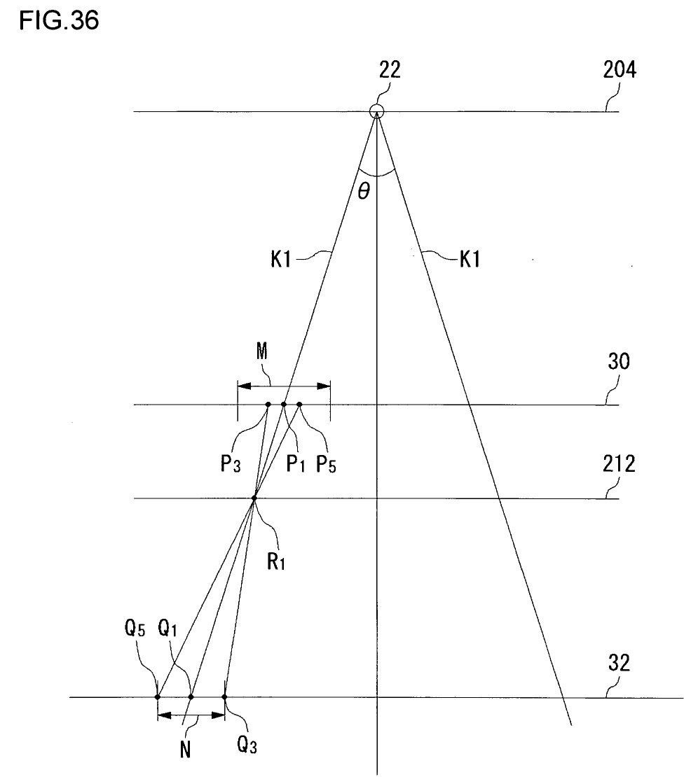

FIG. 36 illustrates how the combined view volume is generated by using preferentially the farther-positioned maximum parallax amount N. The same reference numbers are used for the same components as shown in FIG. 6 and their repeated explanation will be omitted as appropriate. As shown in FIG. 22, if the farther-positioned maximum parallax amount N is given the priority, then the interval between the third front intersecting point P₃ and the fifth front intersecting point P₅ will be smaller than the nearer-positioned parallax amount M. Subsequently, two-dimensional images that do not exceed the limit parallax can be generated. The view volume generator 136, on the other hand, may determine the combined view volume by giving the nearer-positioned maximum parallax amount M a priority.

The view volume generator 136 may decide on preferential use of either the nearer-positioned maximum parallax amount M or the farther-positioned maximum parallax amount N, by determining whether the position of an optical axis intersecting plane 212 lies relatively in front of or in back of the extent T of a finally used region. More precisely, the preferential use of either the nearer-positioned maximum parallax amount M or the farther-positioned maximum parallax amount N may be decided by determining whether the optical axis intersecting plane 212 that the user desires is in the front or in the back relative to the position of the optical axis intersecting plane 212 derived from the nearer-positioned maximum parallax amount M and the farther-positioned maximum parallax amount N. If the position of the optical axis intersecting plane 212 lies relatively in front of the extent T of a finally used region, the view volume generator 136 gives a priority to the farther-positioned maximum parallax amount N whereas if the position of the optical axis intersecting plane 212 lies relatively in back thereof, it gives a priority to the nearer-positioned maximum parallax amount M. This is because if the position of the optical axis intersecting plane 212 lies relatively in front of the extent T of a finally used region and the nearer-positioned maximum parallax amount M is given the priority, the distance between the optical axis intersecting plane 212 and the rearmost object plane 32 is relatively large and therefore it is highly probable that the interval between the third rear intersecting point Q₃ and the fifth rear intersecting point Q₅ will exceed the range of the farther-positioned maximum parallax amount N.

In the present embodiments, the temporary camera 22 is used to simply generate the combined view volume V₁. As another modification, the temporary camera 22 may generate the two-dimensional images as well as the combined view volume V₁. Subsequently, an odd number of two-dimensional images can be generated.

In the present embodiments, the cameras are placed in the horizontal direction. As still another modification, they may be placed in the vertical direction instead and the same advantageous effect is also achieved as in the horizontal direction.

In the present embodiments, the nearer-positioned maximum parallax amount M and the farther-positioned maximum parallax amount N are set in advance. As still another modification, these amounts are not necessarily set beforehand. It suffices as long as the three-dimensional image processing apparatus 100 generates a combined view volume that covers view volumes, for the respective real cameras, within the placement conditions, such as various parameters, for a plurality of cameras set in predetermined positions. Thus it suffices if values corresponding respectively to the nearer-positioned maximum parallax amount M and the farther-positioned maximum parallax amount N are calculated under such conditions.

In the seventh embodiment, the compression processing is performed on the object in a manner such that the farther the position of the object in the depth direction from the temporary camera, the higher a compression ratio in the depth direction. As a modification, a compression processing different from said compression processing is described herein. The normalizing transformation unit 137 according to this modification performs the compression processing such that a compression ratio in the depth direction becomes small gradually toward a certain point in the depth direction from the temporary viewpoints placed by the object defining unit 132 and the compression ratio in the depth direction becomes large gradually in the depth direction from a certain point.

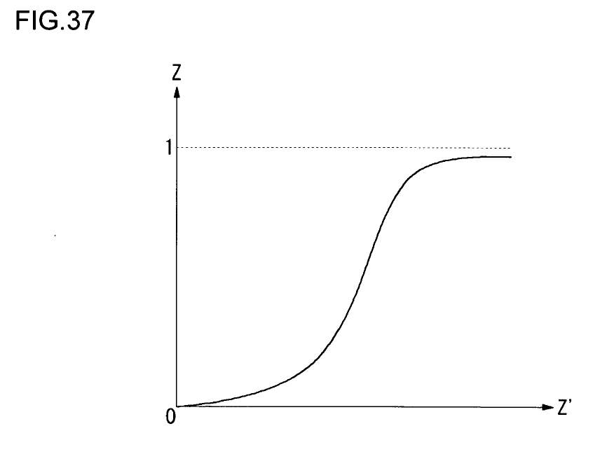

FIG. 37 illustrates a third relationship between a value in the Z′-axis direction and that in the Z-axis direction in a compression processing. Under the third relationship, the normalizing transformation unit 137 can perform compression processing on an object in such a manner that as the value in the Z′-axis direction becomes small starting from a certain value, the decreased amount of the value in the Z-axis direction against the decreased amount thereof in the Z′-axis direction is made small. Also, the normalizing transformation unit 137 can perform compression processing on an object in such a manner that as the value in the Z′-axis direction becomes large starting from a certain value, the increased amount of the value in the Z-axis direction against the increased amount thereof in the Z′-axis direction is made small.

For example, when in the virtual three-dimensional space there is an object that moves at every frame, there are some cases where part of the object flies out in front of or in the depth direction of the combined view volume V₁ prior to the normalizing transformation. The present modification is particularly effective in such a case, and this modification can prevent part of moving object from flying out of the combined view volume V₁ which has been transformed to a normalized coordinate system. Decision on which of two compression processings in the seventh embodiment to be used and which compression processing in the modifications to be used may be automatically made by programs within the three-dimensional image processing apparatus 100 or may be selected by the user.

Although the present invention has been described by way of exemplary embodiments and modified examples, it should be understood that many other changes and substitutions may further be made by those skilled in the art without departing from the scope of the present invention which is defined by the appended claims.

1. A three-dimensional image processing apparatus that displays an object within a virtual three-dimensional space based on two-dimensional images from a plurality of different viewpoints, the apparatus including:
a view volume generator which generates a combined view volume that contains view volumes defined by the respective plurality of viewpoints.

2. A three-dimensional image processing apparatus according to claim 1, further including:
an object defining unit which positions the object within the virtual three-dimensional space; and
a temporary viewpoint placing unit which places a temporary viewpoint within the virtual three-dimensional space,
wherein said view volume generator generates the combined view volume based on the temporary viewpoint placed by said temporary viewpoint placing unit.

3. A three-dimensional image processing apparatus according to claim 1, further including:
a coordinate conversion unit which performs coordinate conversion on the combined view volume and acquires a view volume for each of the plurality of viewpoints; and
a two-dimensional image generator which projects the acquired view volume for the each of the plurality of viewpoints, on a projection plane and which generates the two-dimensional image for the each of the plurality of viewpoints.

4. A three-dimensional image processing apparatus according to claim 1, wherein said view volume generator generates a single piece of the combined view volume.

5. A three-dimensional image processing apparatus according to claim 1, wherein said coordinate conversion unit acquires a view volume for each of the plurality of viewpoints by subjecting the view volume to skewing transformation.

6. A three-dimensional image processing apparatus according to claim 1, wherein said coordinate conversion unit acquires a view volume for each of the plurality of viewpoints by subjecting the view volume to rotational transformation.

7. A three-dimensional image processing apparatus according to claim 1, wherein said view volume generator generates the combined view volume by increasing a viewing angle of the temporary viewpoint.

8. A three-dimensional image processing apparatus according to claim 1, wherein said view volume generator generates the combined view volume by the use of a front projection plane and a back projection plane.

9. A three-dimensional image processing apparatus according to claim 1, wherein said view volume generator generates the combined view volume by the use of a nearer-positioned maximum parallax amount and a farther-positioned maximum parallax amount.

10. A three-dimensional image processing apparatus according to claim 1, wherein said view volume generator generates the combined view volume by the use of either a nearer-positioned maximum parallax amount or a farther-positioned maximum parallax amount.

11. A three-dimensional image processing apparatus according to claim 2, further including:
a normalizing transformation unit which transforms the combined view volume generated into a normalized coordinate system,
wherein said normalizing transformation unit performs a compression processing in a depth direction on the object positioned by said object defining unit, according to a distance in the depth direction from the temporary viewpoint placed by said temporary viewpoint placing unit.

12. A three-dimensional image processing apparatus according to claim 11, wherein said normalizing transformation unit performs the compression processing in a manner such that the larger the distance in the depth direction, the higher a compression ratio in the depth direction.

13. A three-dimensional image processing apparatus according to claim 11, wherein said normalizing transformation unit performs the compression processing such that a compression ratio in the depth direction becomes small gradually toward a point in the depth direction from the temporary viewpoint placed by said temporary viewpoint placing unit and the compression ratio in the depth direction becomes large gradually in the depth direction from a point.

14. A three-dimensional image processing apparatus according to claim 9, further including a parallax control unit which controls the nearer-positioned maximum parallax amount or the farther-positioned maximum parallax amount so that a parallax formed by a ratio of the width to the depth of an object expressed within a three-dimensional image at the time of generating the three-dimensional image does not exceed a parallax range properly perceived by human eyes.

15. A three-dimensional image processing apparatus according to claim 9; further including:
an image determining unit which performs frequency analysis on a three-dimensional image to be displayed based on a plurality of two-dimensional images corresponding to different parallaxes; and
a parallax control unit which adjusts the nearer-positioned maximum parallax amount or the farther-positioned maximum parallax amount according to an amount of high frequency component determined by the frequency analysis.

16. A three-dimensional image processing apparatus according to claim 15, wherein if the amount of high frequency component is large, said parallax control unit adjusts the nearer-positioned maximum parallax amount or the farther-positioned maximum parallax amount by making it larger.

17. A three-dimensional image processing apparatus according to claim 9, further including:
an image determining unit which detects movement of a three-dimensional image displayed based on a plurality of two-dimensional images corresponding to different parallaxes; and
a parallax control unit which adjusts the nearer-positioned maximum parallax amount or the farther-positioned maximum parallax amount according to an amount of movement of the three-dimensional image.

18. A three-dimensional image processing apparatus according to claim 17, wherein if the amount of movement of the three-dimensional image is large, said parallax control unit adjusts the nearer-positioned maximum parallax amount or the farther-positioned maximum parallax amount by making it larger.

19. A method for processing three-dimensional images, the method including:
positioning an object within a virtual three-dimensional space;
placing a temporary viewpoint within the virtual three-dimensional space;
generating a combined view volume that contains view volumes set respectively by a plurality of viewpoints by which to produce two-dimensional images having parallax, based on the temporary viewpoint placed within the virtual three-dimensional space;
performing coordinate conversion on the combined view volume and acquiring a view volume for each of the plurality of viewpoints; and
projecting the acquired view volume for the each of the plurality of viewpoints, on a projection plane and generating the two-dimensional image for the each of the plurality of viewpoints.
